(19) United States
(12) Patent Application Publication
(10) Pub. No.: US 2005/0209785 A1
(43) Pub. Date: Sep. 22, 2005

(54) Systems and methods for disease diagnosis

(76) Inventors: Martin D. Wells, Needham, MA (US); Christopher T. Turner, Belmont, MA (US); Peter N. Jacobson, Goshen, CT (US)

Correspondence Address: JONES DAY, 222 EAST 41ST ST, NEW YORK, NY, 10017, US

(21) Appl. No.: 11/068,102

(22) Filed: Feb. 27, 2005

Related U.S. Application Data
(60) Provisional application No. 60/548,560, filed on Feb. 27, 2004.

(51) Int. Cl. G06E 1/00; G06G 7/00; G06F 15/18; G06F 19/00

(52) U.S. Cl. 702/19; 706/16

(57) ABSTRACT

The present invention is directed to improved systems and methods for distinguishing and classifying subjects based on analysis of biological materials. Methods for the analysis of multivariate data collected from a plurality of subjects of known class are provided. The results of such analyses include a set of intermediate combined classifiers as well as a metal variable that relates directly to the classes of the subjects in a training population. Both the intermediate combined classifiers and the final meta model are used to distinguish and classify subjects of previously unknown class.

### CROSS-REFERENCE TO RELATED APPLICATIONS

This application claims benefit, under 35 U.S.C. § 119(e), of U.S. Provisional Patent Application No. 60/548,560, filed on Feb. 27, 2004, which is hereby incorporated by reference in its entirety.

### 1. FIELD OF THE INVENTION

The present invention relates to methods and tools for the development and implementation of medical diagnostics based on the identification of patterns in multivariate data derived from the analysis of biological samples collected from a training population.

### 2. BACKGROUND

Historically, laboratory-based clinical diagnostic tools have been based on the measurement of specific antigens, markers, or metrics from sampled tissues or fluids. In this diagnostic paradigm, known substances or metrics (e.g., prostate specific antigen and percent hematocrit, respectively) are measured and compared against established normal measurement ranges. The substances and metrics that make up these laboratory diagnostic tests are determined either pathologically or epidemiologically.

Pathological determination is dependent upon a clear understanding of the disease process, the products and byproducts of that process, and/or the underlying cause of disease symptoms. Pathologically-determined diagnostics are generally derived through specific research aimed at developing a known substance or marker into a diagnostic tool.

Epidemiologically-derived diagnostics, on the other hand, typically stem from an experimentally-validated correlation between the presence of a disease and the up- or down-regulation of a particular substance or otherwise measurable parameter. Observed correlations that might lead to this type of laboratory diagnostics can come from exploratory studies aimed at uncovering those correlations from a large number of potential candidates, or they might be observed serendipitously during the course of research with goals other than diagnostic development.

While laboratory diagnostics derived from clear pathologic knowledge or hypothesis are more frequently in use today, epidemiologically-determined tests are potentially more valuable overall given their ability to reveal new and unexpected information about a disease and thereby provide feedback into the development of associated therapies and novel research directions.

Recently, significant interest has been generated by the concept of disease fingerprinting for medical diagnostics. This approach pushes the limits of epidemiologically-derived diagnostics by using pattern classification to uncover subtle and complicated relationships among a large number of measured variables.

General methods of determining the class or appropriate grouping of a subject of a known type but of an a priori unknown class is known to those of skill in the art and is generally described by the following procedure.

Step A. Collect a large number of biological samples of the same type but from a plurality of known, mutually-exclusive subject classes, the training population, where one of the subject classes represented by the collection is hypothesized to be an accurate classification for a biological sample from a subject of unknown subject class.

Step B. Measure a plurality of quantifiable physical variables (physical variables) from each biological sample obtained from the training population.

Step C. Screen the plurality of measured values for the physical variables using statistical or other means to identify a subset of physical variables that separate the training population by their known subject classes.

Step D. Determine a discriminant function of the selected subset of physical variables that, through its output when applied to the measured variable values from the training population, separates biological samples from the training population into their known subject classes.

Step E. Measure the same subset of physical variables from a biological sample derived or obtained from a subject not in the training population (a test biological sample).

Step F. Apply the discriminant function to the values of the identified subset of physical variables measured from the test sample.

Step G. Use the output of the discriminant function to determine the subject class, from among those subject classes represented by the training population, to which the test sample belongs.

Due to the complexity of the methods used for variable measurement and data processing in this generalized approach, the relationships that are uncovered in this manner may or may not be traceable to underlying substances, regulatory pathways, or disease processes. Nonetheless, the potential to use these otherwise obscured patterns to produce insight into various diseases and the preliminarily reported efficacy of diagnostics derived using these methods is looked on by many as the likely source of the next great wave of medical progress.

The basis of disease fingerprinting is generally the analysis of tissues or biofluids through chemical or other physical means to generate a multivariate set of measured variables. One common analysis tool for this purpose is mass spectrometry, which produces spectra indicating the amount of ionic constituent material in a sample as a function of each measured component's mass-to-charge (m/z) ratio. A collection of spectra are gathered from subjects belonging to two or more identifiable classes. For disease diagnosis, useful subject classes are generally related to the existence or progression of a specific pathologic process. Gathered spectra are mathematically processed so as to identify relationships among the multiple variables that correlate with the predefined subject classes. Once such relationships (also referred to as patterns, classifiers, or fingerprints) have been identified, they can be used to predict the likelihood that a subject belongs to a particular class represented in the training population used to build the relationships. In practice, a large set of spectra, termed the training or development dataset, is collected and used to identify and define diagnostic patterns that are then used to prospectively analyze the spectra of subjects that are members of the testing, validation, or unknown dataset and that were not part of the training dataset to suggest or provide specific information about such subjects.

There are a number of data analysis methods that have been implemented and documented with application to disease fingerprinting. Analysis methods fall under the headings of pattern recognition, classification, statistical analysis, machine learning, and discriminator analysis to name a few. Within those methods, particular algorithms that are known to those of skill in the art and that have been employed include k-means, k-nearest neighbors, artificial neural networks, t-test hypothesis testing, genetic algorithms, self-organizing maps, as well as principal component regression. See, for example, Duda et al., 2001, Pattern Classification, John Wiley & Sons, Inc.; Hastie et al., 2001, The Elements of Statistical Learning: Data Mining, Inference, and Prediction, Springer, N.Y.; and Agresti, 1996, An Introduction to Categorical Data Analysis, John Wiley & Sons, New York, which are hereby incorporated by reference in their entirety. The manner in which these building-block algorithms are implemented and combined can vary significantly. Different methods can be more effective for different types of multivariate data or for different types of classification (e.g., diagnostic vs. prognostic).

Methods for disease fingerprinting utilizing the above methods have been documented in various references. See, for example, Hitt, “Heuristic Method of Classification,” U.S. Patent Publication No. 2002/0046198, published Apr. 18, 2002; Hitt et al., “Process for discriminating between biological states based on hidden patterns from biological data,” U.S. Patent Publication No. 2003/0004402, published Jan. 2, 2003; Petricoin et al., 2002, “Use of proteomic patterns in serum to identify ovarian cancer,” Lancet 359, pp. 572-7; Lilien et al., 2003, “Probabilistic Disease Classification of Expression-Dependent Proteomic Data from Mass Spectrometry of Human Serum,” Journal of Computational Biology, 10, pp. 925-946; Zhu et al., 2003, “Detection of cancer-specific markers amid massive mass spectral data,” Proceedings of the National Academy of Sciences 100, pp. 14666-14671; and Wang et al., 2003 “Spectral editing and pattern recognition methods applied to high-resolution magic-angle spinning 1H nuclear magnetic resonance spectroscopy of liver tissues,” Analytic Biochemistry 323, pp. 26-32; each of which is hereby incorporated by reference in its entirety.

Specifically, Hitt et al. “Process for discriminating between biological states based on hidden patterns from biological data,” U.S. Patent Publication No. 2003/0004402, published Jan. 2, 2003 disclose a method whereby a genetic algorithm is employed to select feature subsets as possible discriminatory patterns. In this method, feature subsets are selected randomly at first and their ability to correctly segregate the dataset into known classes is determined. As further described in Petricoin et al., 2002, “Use of proteomic patterns in serum to identify ovarian cancer,” Lancet 359, pp. 572-7, the ability or fitness of each tested feature subset to segregate the data is based on an adaptive k-means clustering algorithm. However, other known clustering means could also be used. At each iteration of the genetic algorithm, feature subsets with the best performance (fitness) are retained while others are discarded. Retained feature subsets are used to randomly generate additional, untested combinations and the process repeats using these and additional, randomly-generated feature subsets.

There are a number of disadvantages to using such a genetic algorithm approach. First, the approach does not guarantee a sampling or even an initial screening of the entire solution subspace. This creates a situation where very complex solutions can be returned even though much simpler solutions may exist. Second, the random nature of the genetic algorithm leads to a potentially unstable initial condition so that different solutions can be found even when applying the method multiple times to the same training dataset. Returning a different solution each time it is applied renders any claims about the importance of any one particular solution component difficult to make. It also unnecessarily complicates the process of cross-validation, which is a mandatory component of disease fingerprint development and validation. Third, the size of the feature subset to use is a necessary parameter of the approach. Yet, there is no suggested method of determining or estimating that size without running the algorithm for many feature subset sizes and selecting the best based on the results. Finally, genetic algorithms of this type, while less taxing than comprehensive sampling of all possible feature subsets, are nonetheless time consuming and computationally intensive.

Lilien et al. 2003, “Probabilistic Disease Classification of Expression-Dependent Proteomic Data from Mass Spectrometry of Human Serum,” Journal of Computational Biology 10, pp. 925-946, have overcome some of the disadvantages mentioned above through the development and implementation of a deterministic algorithm based on principal components analysis of the measured spectra followed by linear discriminant analysis of the calculated principal component coefficients. A significant disadvantage of the Lilien et al. approach is its inability to smoothly scale as additional data are incorporated into the training dataset. The inclusion of new data alters the form of the principal components associated with the spectral dataset, thereby rendering the previously calculated principal component coefficients and linear discriminator coefficients meaningless. The degree to which additional data will affect prior solutions for the algorithm they describe is a function of the increase in ensemble variance due to inclusion of the new data and cannot therefore be predicted. Another disadvantage of the Lilien et al. approach is that the intermediate values (principal components and principal component coefficients) that are generated cannot be projected back to determine the underlying chemical or physical basis for disease discrimination. This removes the ability to develop or improve therapies or to direct basic research from the generated solutions and limits the utility of the solutions solely to diagnostic applications.

Zhu et al., 2003, “Detection of cancer-specific markers amid massive mass spectral data,” Proceedings of the National Academy of Sciences 100, pp. 14666-14671, describe a method that uses statistical hypothesis testing to first screen for individual variables within the spectrum that have the strongest discriminatory power and then applies a k-nearest neighbor algorithm to only the most discriminatory features to perform classification. Zhu et al. first reduce the large multivariate dataset to a smaller number of discriminatory variables and then combine those variables through the calculation of a distance metric to classify both known and unknown subjects. One potential disadvantage of this approach is that the methods used for data reduction (statistical hypothesis testing) and those actually used for classification (nearest neighbors based on distance) do not match. The approach ends up discarding variables based on statistical testing that may have contributed very strongly to the ultimate classification scheme. It can be shown empirically that strength in one of these metrics does not guarantee strength in the other and that they may be negatively correlated in some situations. A further disadvantage of Zhu et al. is that there is no accommodation made for intermediate values, combinations, or indicators that might be used to further subdivide the subjects, provide differential diagnosis, or identify otherwise unknown patterns among the subjects that are related to health. Furthermore, the method requires incrementally increasing the size of the model until a performance threshold has been met. This approach puts no limit on the size of the model or the number of calculation steps required to achieve convergence. Finally, the Zhu et al. approach is unsatisfactory because it is intrinsically highly computationally intensive, requiring an exhaustive search of all possible combinations of suitable biomarkers.

Citation or identification of any reference in this section or any section of this application shall not be construed to mean that such reference is available as prior art to the present invention.

### 3. SUMMARY

Methods and devices for identifying discriminatory patterns in multivariate datasets are provided. One embodiment of the present invention provides a method in which the application of a first discriminatory analysis stage is used for initial screening of individual discriminating variables to include in the solution. Following initial individual discriminating variable selection, subsets of selected individual discriminating variables are combined, through use of a second discriminatory analysis stage, to form a plurality of intermediate combined classifiers. Finally, the complete set of intermediate combined classifiers is assembled into a single meta classifier using a third discriminatory analysis stage. As such, the systems and methods of the present invention combine select individual discriminating variables into a plurality of intermediate combined classifiers which, in turn, are combined into a single meta classifier.

Once determined from the training dataset, the selected individual discriminating variables, each of the intermediate combined classifiers, and the single meta classifier can be used to discern or clarify relationships between subjects in the training dataset and to provide similar information about data from subjects not in the training dataset.

The meta classifiers of the present invention are closed-form solutions, as opposed to stochastic search solutions, that contain no random components and remain unchanged when applied multiple times to the same training dataset. This advantageously allows for reproducible findings and an ability to cross-validate potential pattern solutions.

In typical embodiments, each element of the solution subspace is completely sampled. An initial screen is performed during which each variable in the multivariate training dataset is sampled. Exemplary variables are (i) mass spectral peaks in a mass spectrometry dataset obtained from a biological sample and (ii) nucleic acid abundances measured from a nucleic acid microarray. Those that demonstrate diagnostic utility are retained as individual discriminating variables. Furthermore, in a preferred embodiment, the initial screen is performed using a classification method that is complementary to that used to generate the meta classifier. This improves on other reported methods that use disparate strategies to initially screen and then to ultimately classify the data.

In the present invention, straightforward algorithmic techniques are utilized in order to reduce computational intensity and reduce solution time. There are no iterative processes or large exhaustive combinatorial searches inherent in the systems and methods of the present invention that would require convergence to a final solution with an unknown time requirement. Given a priori knowledge of the number and type of multivariate data used for training, the computational burden and memory requirements of the systems and methods of the present invention can be fully characterized prior to implementation.

As new training data becomes available, the systems and methods of the present invention allow for the incorporation of such data into the meta classifier and the direct use of such data in classifying subjects not in the training population. In other words, when new information becomes available, the systems and methods of the present invention can immediately incorporate such information into the diagnostic solution and begin using the new information to help classify other unknowns.

At each step of the inventive methods the meta classifier as well as the intermediate combined classifiers can all be traced back to chemical or physical sources in the training dataset based on, for example, the method of spectral measurement.

Initial and intermediate data structures derived by the methods of the present invention, including the individual discriminating variables and each of the intermediate combined classifiers contain useful information regarding subject class and can be used to define subject subclasses, to suggest in either a supervised or unsupervised fashion other unseen relationships between subjects, or allow for the incorporation of multi-class information.

One embodiment of the present invention provides a method of identifying one or more discriminatory patterns in multivariate data. In step a) of the method, a plurality of biological samples are collected from a corresponding plurality of subjects belonging to two or more known subject classes (training population) such that each respective biological sample in the plurality of biological samples is assigned the subject class, in the two or more known subject classes, of the corresponding subject from which the respective sample was collected. Each subject in the plurality of subjects is a member of the same species. In step b) of the method, a plurality of physical variables are measured from each respective biological sample in the plurality of biological samples such that the measured values of the physical variables for each respective biological sample in the plurality of biological samples are directly comparable to corresponding ones of the physical variables across the plurality of biological samples. In step c) of the method, each respective biological sample in the plurality of biological samples is classified based on a measured value for a first physical variable of the respective biological sample compared with corresponding ones of the measured values from step b) for the first plurality of physical variables of other biological samples in the plurality of biological samples. In step d) of the method, an independent score is assigned to the first physical variable that represents the ability for the first physical variable to accurately classify the plurality of biological samples into correct ones of the two or more known subject classes. In step e) of the method, steps c) and d) are repeated for each physical variable in the plurality of physical variables, thereby assigning an independent score to each physical variable in the plurality of physical variables.

Next, in step f) those physical variables in the plurality of physical variables that are best able to classify the plurality of biological samples into correct ones of said two or more known subject classes (as determined by steps c) through e) of the method) are retained as a plurality of individual discriminating variables. In step g) of the method, a plurality of groups is constructed. Each group in the plurality of groups comprises an independent subset of the plurality of individual discriminating variables. In step h) of the method, each individual discriminating variable in a group in the plurality of groups is combined thereby forming an intermediate combined classifier. In step i) of the method, step h) is repeated for each group in the plurality of groups, thereby forming a plurality of intermediate combined classifiers. In step j) of the method the plurality of intermediate combined classifiers are combined into a meta classifier. This meta classifier can be used to classify subjects into correct ones of said two or more known subject classes regardless of whether such subjects were in the training population.

Another aspect of the invention provides a method of identifying and recognizing patterns in multivariate data derived from the analysis of biofluid. In this aspect of the invention, biofluids are collected from a plurality of subjects belonging to two or more known subject classes where subject classes are defined based on the existence, absence, or relative progression of one or more pathologic processes. Next, the biofluids are analyzed through chemical, physical or other means so as to produce a multivariate representation of the contents of the fluids for each subject. A nearest neighbor classification algorithm is then applied to individual variables within the multivariate representation dataset to determine the variables (individual classifying variables) that are best able to discriminate between a plurality of subject classes—where discriminatory ability is based on a minimum standard of better-than-chance performance. Individual classifying variables are linked together into a plurality of groups based on measures of similarity, difference, or the recognition of patterns among the individual classifying variables. Linked groups of individual classifying variables are combined into intermediate combined classifiers containing a combination of diagnostic or prognostic information (potentially unique or independent) from the constituent individual classifying variables. Preferably, each intermediate combined classifier provides diagnostic or prognostic information beyond that of any of its constituent individual classifying variables alone. A plurality of intermediate combined classifiers are combined into a single diagnostic or prognostic variable (meta classifier) that makes use of the information (potentially unique or independent) available in each of the constituent intermediate combined classifiers. In preferred embodiments, this meta classifier provides diagnostic or prognostic information beyond that of any of its constituent intermediate combined classifiers alone.

Another aspect of the present invention provides a method of classifying an individual based on a comparison of multivariate data derived from the analysis of that individual's biological sample with patterns that have previously been identified or recognized in the biological samples of a plurality of subjects belonging to a plurality of known subject classes where subject classes were defined based on the existence, absence, or relative progression of a pathologic processes of interest, the efficacy of a therapeutic regimen, or toxicological reactions to a therapeutic regimen. In this aspect of the invention, biological samples are collected from an individual subject and analyzed through chemical, physical or other means so as to produce a multivariate representation of the contents of the biological samples. A nearest neighbors classification algorithm and a database of similarly analyzed multivariate data from multiple subjects belonging to two or more known subject classes where subject classes are defined based on the existence, absence, or relative progression of one or more pathologic processes, the efficacy of a therapeutic regimen, or toxicological reactions to a therapeutic regimen are used to calculate a plurality of classification measures based on individual variables (individual classifying variables) that have been predetermined to provide discriminatory information regarding subject class. The plurality of classification measures are combined in a predetermined manner into one or more variables which number of variables is able to classify the diagnostic or prognostic state of the individual.

### 4. BRIEF DESCRIPTION OF THE DRAWINGS

The present invention may be understood more fully by reference to the following detailed description of the preferred embodiment of the present invention, illustrative examples of specific embodiments of the invention and the appended figures in which:

FIG. 1 illustrates the determination of individual discriminatory variables, intermediate combined classifiers, and a meta classifier in accordance with an embodiment of the present invention.

FIG. 2 illustrates the classification of subjects not in a training population using a meta classifier in accordance with an embodiment of the present invention.

FIG. 3 illustrates the sensitivity/specificity distribution among all individual m/z bins within the mass spectra of an ovarian cancer dataset in accordance with an embodiment of the present invention.

FIG. 4 illustrates the frequency with which each component of a mass spectral dataset is selected as an individual discriminating variable in an exemplary embodiment of the present invention.

FIG. 5 illustrates the average sensitivities and specificities of intermediate combined classifiers as a function of the number of individual discriminating variables included within such classifiers in accordance with an embodiment of the present invention.

FIG. 6 illustrates the distribution of sensitivities and specificities for all intermediate combined classifiers calculated in a 1000 cross-validations trial using an ovarian cancer training population in accordance with an embodiment of the present invention.

FIG. 7 illustrates the distribution of sensitivities and specificities for all intermediate combined classifiers determined from the FIG. 6 training population calculated in a 1000 cross-validations trial using a blinded ovarian cancer testing population separate and distinct from the training population in accordance with an embodiment of the present invention.

FIG. 8 illustrates the performance of meta classifiers when applied to the testing data in accordance with an embodiment of the present invention.

FIG. 9 illustrates an exemplary system in accordance with an embodiment of the present invention.

### 5. DETAILED DESCRIPTION

The present invention will be further understood through the following detailed description.

### 5.1. Overview

In one embodiment of the present invention a method having the following steps is provided.

Step 102. Collect, access or otherwise obtain data descriptive of a number of biological samples from a plurality of known, mutually-exclusive classes (the training population), where one of the classes represented by the collection is hypothesized to be an accurate classification for a sample of unknown class. In some embodiments, more than 10, more than 100, more than 1000, between 5 and 5,000, or less than 10,000 biological samples are collected. In some embodiments each of these biological samples is from a different subject in a training population. In some embodiments, more than one biological sample type is collected from each subject in the training population. For example a first biological sample type can be a biopsy from a first tissue type in a given subject whereas a second biological sample type can be a biopsy from a second tissue type in the subject. In some embodiments the biological sample taken from a subject for the purpose of obtaining the data measured or obtained in step 102 is a tissue, blood, saliva, plasma, nipple aspirants, synovial fluids, cerebrospinal fluids, sweat, urine, fecal matter, tears, bronchial lavage, swabbings, needle aspirants, semen, vaginal fluids, and/or pre-ejaculate sample.

In some embodiments, the training population comprises a plurality of organisms representing a single species (e.g., humans, mice, etc.). The number of organisms in the species can be any number. In some embodiments, the plurality of organisms in the training population is between 5 and 100, between 50 and 200, between 100 and 500, or more than 500 organisms. Representative biological samples can be a blood sample or a tissue sample from subjects in the training population.

Step 104. In this step, a plurality of quantifiable physical variables are measured (or otherwise acquired) from each sample in the collection obtained from the training population. In some embodiments, these quantifiable physical variables are mass spectral peaks obtained from mass spectra of the samples respectively collected in step 202. In other embodiments, such data comprise gene expression data, protein abundance data, microarray data, or electromagnetic spectroscopy data. More generally, any data that result in multiple similar physical measurements made on each physiologic sample derived from the training population can be used in the present invention. For instance, quantifiable physical variables that represent nucleic acid or ribonucleic acid abundance data obtained from nucleic acid microarrays can be used. Techniques for acquiring such nucleic acid microarray data are described in, for example, Draghici, 2003, Data Analysis Tools for DNA Microarrays, Chapman & Hall, CRC Press London, which is hereby incorporated by reference in its entirety. In still other embodiments, these quantifiable physical variables represent protein abundance data obtained, for example, from protein microarrays (e.g., The ProteinChip® Biomarker System, Ciphergen, Fremont, Calif.). See also, for example, Lin, 2004, Modern Pathology, 1-9; Li, 2004, Journal of Urology 171, 1782-1787; Wadsworth, 2004, Clinical Cancer Research, 10, 1625-1632; Prieto, 2003, Journal of Liquid Chromatography & Related Technologies 26, 2315-2328; Coombes, 2003, Clinical Chemistry 49, 1615-1623; Mian, 2003, Proteomics 3, 1725-1737; Lehre et al., 2003, BJU International 92, 223-225; and Diamond, 2003, Journal of the American Society for Mass Spectrometry 14, 760-765, each of which is hereby incorporated by reference in their entirety.

Although somewhat dependent on the type of data measured, ranges of numbers of physical variables measured in step 104 can be given. In various embodiments, more than 50 physical variables, more than 100 physical variables, more than 1000 physical variables, between 40 and 15,000 physical variables, less than 25,000 physical variables or more than 25,000 physical variables are measured from each biological sample in the training set (derived or obtained from the training population) in step 104.

Step 106. In step 106, the set of variable values obtained for each biological sample obtained from the training population in step 104 is screened through statistical or other algorithmic means in order to identify a subset of variables that separate the biological samples by their known subject classes. Variables in this subset are referred to herein as individual discriminating variables. In some embodiments, more than five individual discriminating variables are selected from the set of variables identified in step 104. In some embodiments, more than twenty-five individual discriminating variables are selected from the set of variables identified in step 104. In still other embodiments, more than fifty individual discriminating variables are selected from the set of variables identified in step 104. In yet other embodiments, more than one hundred, more than two hundred, or more than 300 individual discriminating variables are selected from the set of variables identified in step 104. In some embodiments, between 10 and 300 individual discriminating variables are selected from the set of variables identified in step 104.

In step 106, each respective physical variable obtained in step 104 is assigned a score. These scores represent the ability of each of the physical variables corresponding to the scores to, independently, correctly classify the training population (a plurality of biological samples derived from the training population) into correct ones of the known subject classes. There is no limit on the types of scores used in the present invention and their format will depend largely upon the type of analysis used to assign the score. There are a number of methods by which an individual discriminating variable can be identified in the set of variable values obtained in step 104 using such scoring techniques. Exemplary methods include, but are not limited to, a t-test, a nearest neighbors algorithm, and analysis of variance (ANOVA). T-tests are described in Smith, 1991, Statistical Reasoning, Allyn and Bacon, Boston, Mass., pp. 361-365, 401-402, 461, and 532, which is hereby incorporated by reference in its entirety. T-tests are also described in Draghici, 2003, Data Analysis Tools for DNA Microarrays, Chapman & Hall, CRC Press London, Section 6.2, which is hereby incorporated by reference in its entirety. The nearest neighbors algorithm is describe in Duda et al., 2001, Pattern Classification, John Wiley & Sons, Inc., Section 4.5.5, which is hereby incorporated by reference in its entirety. ANOVA is described in Draghici, 2003, Data Analysis Tools for DNA Microarrays, Chapman & Hall, CRC Press London, Chapter 7, which is hereby incorporated by reference in its entirety. Each of the above-identified techniques classifies the training population based on the values of the individual discriminating variables across the training population. For instance, one variable may have a low value in each member of one subject class a high value in each member of a different subject. A technique such as a t-test will quantify the strength of such a pattern. In some embodiments, the values for one variable across the training population may cluster in discrete ranges of values. A nearest neighbor algorithm can be used to identify and quantify the ability for this variable to discriminate the training population into the know subject classes based on such clustering. In some embodiments, the score is based on one or more of a number of biological samples classified correctly in a subject class, a number of biological samples classified incorrectly in a subject class, a relative number of biological samples classified correctly in a subject class, a relative number of biological samples classified incorrectly in a subject class, a sensitivity of a subject class, a specificity of a subject class, or an area under a receiver operator curve computed for a subject class based on results of the classifying. In some embodiments, functional combinations of such criteria are used. For instance, in some embodiments, sensitivity and specificity are used, but are combined in a weighted fashion based on a predetermined relative cost or other scoring of false positive versus false negative classification.

In some embodiments, the score is based on a p value for a t-test. In some embodiments, a physical variable must have a threshold score such as 0.10 or better, 0.05 or better, or 0.005 or better in order to be selected as an individual discriminating variable.

Step 108. A plurality of non-exclusive subgroups of the individual discriminating variables of step 106 is determined in step 108. Section 5.3, below, describes various methods for partitioning individual discriminating variables into subgroups for use as intermediate combined classifiers. In some embodiments, selection of such subgroups of individual discriminating variables for use in discrete intermediate combined classifiers is based on any combination of the following criteria:
a) an ability of each individual discriminating variable in a respective subgroup to classify subjects in the training population, by itself, into their known subject class or classes;
b) similarities or differences in a respective subgroup with respect to the identity of specific subjects from the training population that each variable in the respective subgroup is able, by itself, to classify;
c) similarities or differences in the type of quantifiable physical measurements represented by the individual discriminating variables in the subgroup;
d) similarities or differences in the range, variation, or distribution of individual discriminatory variable values measured from samples from subjects in the training population among the individual discriminatory variables in the subgroup;
e) the supervised clustering or organization of individual discriminating variables based on their attributes and on information about subclasses that exist within the training population; and/or
f) the unsupervised clustering of individual discriminating variables based on their attributes.

Representative clustering techniques that can be used in step 108 are described in Section 5.8, below. In some embodiments, between two and one thousand non-exclusive subgroups (groups) of individual discriminating variables are identified in step 108. In some embodiments, between five and one hundred non-exclusive subgroups (groups) of individual discriminating variables are identified in step 108. In some embodiments, between two and fifty non-exclusive subgroups (groups) of individual discriminating variables are identified in step 108. In some embodiments, more than two non-exclusive subgroups (groups) of individual discriminating variables are identified in step 108. In some embodiments, less than 100 non-exclusive subgroups (groups) of individual discriminating variables are identified in step 108. In some embodiments, the same individual discriminating variable is present in more than one of the identified non-exclusive subgroups. In some embodiments, each subgroup has a unique set of individual discriminating variables. The present invention places no particular limitation on the number of individual discriminating variables that can be found in a given sub-group. In fact, each sub-group may have a different number of individual discriminating variables. For purposes of illustration only, and not by way of limitation, a given non-exclusive subgroup can have between two and five hundred individual discriminating variables, between two and fifty individual discriminating variables, more than two individual discriminating variables, or less than 100 individual discriminating variables.

Step 110. For each subgroup of individual discriminating variables, one or more functions of the individual discriminating variables in the subgroup (the low-level functions) are determined. Such low-level functions are referred to herein as intermediate combined classifiers. Section 5.4, below, describes various methods for computing such intermediate combined classifiers. Each such intermediate combined classifier, through its output when applied to the individual discriminating variables of that subgroup, is able to:
a) separate biological samples from the training population into their known subject classes;
b) separate a subset of biological samples from the training population into their known subject classes;
c) separate a subset of biological samples from the training population into a plurality of unknown subclasses that may or may not be correlated with the known subject class of those biological samples but that serves as an unsupervised classification of those biological samples;
d) separate a subset of biological samples from the training population, all of which are known to belong to the same subject class, into a plurality of subclasses to which those biological samples are also known to belong; and/or
e) separate a subset of biological samples from the training population, which are known to belong to a plurality of known subject classes, into a plurality of subclasses to which those biological samples are also known to belong.

Step 112. A function (high-level function) that takes as its inputs the outputs of the intermediate combined classifiers determined in the previous step, and whose output separates subjects from the training population into their known subject classes is computed in step 112. This high-level function is referred to herein as a macro classifier. Section 5.5, below, provides more details on how such a computation is accomplished in accordance with the present invention.

Once a macro classifier has been derived by the above-described methods, it can be used to characterize a biological sample that was not in the training data set into one of the subject classes represented by the training data set. To accomplish this, the same subset of physical variables represented by (used to construct) the macro classifier is obtained from a biological sample of the subject that is to be classified. Each of a plurality of low-level functions (intermediate combined classifiers) is applied to the appropriate subset of variable values measured from the sample to be classified. The outputs of the low-level functions (intermediate combined classifiers) individually or in combination are used to determine qualities or attributes of the biological sample of unknown subject class. Then, the high-level function (macro classifier) is applied to the outputs of the low-level functions calculated from the physical variables measured from the sample of unknown class. The output of the high-level function (macro classifier) is then used to determine or suggest the subject class, from among those subject classes represented by the training population, to which the sample belongs. The use of a macro classifier to classify subjects not found in training population is described in Section 5.6, below.

For the purpose of this description and in reference to the procedure outlined above, individual variables that are identified from a set of physical measurements and (at times) the values of those measurements will be referred to as individual discriminating variables (individual classifying variables). Also for the purpose of this description, low-level functions and the outputs of those functions will be referred to as intermediate combined classifiers. Finally for the purpose of this description, high-level functions, and the output of a high-level function will be referred to as meta classifiers.

### 5.2. Selection of Individual Discriminating Variables

Now that an overview of exemplary methods in accordance with the present invention has been given, more details of specific steps and aspects of certain embodiments of the present invention will be provided. Direct reference to statistical and other data processing techniques known to those of skill in the art, including k-nearest neighbors (KNN), will be made. It should be understood that alternative data processing techniques, including but not limited to statistical hypothesis testing, that return an output indicating the ability of each individual variable to separate each item into a known set of classes may be used in additional embodiments of the present invention. As such, these alternative techniques are part of the present invention.

In one preferred embodiment of the current invention, individual classifying variables are identified using a KNN algorithm. KNN attempts to classify data points based on the relative location of or distance to some number (k) of similar data of known class. In one embodiment of the present invention, the data point to be classified is the value of one subject's mass spectrum at a particular m/z value [or m/z index]. The similar data of known class consists of the values returned for the same m/z index from the subjects in the development dataset. KNN is used in the identification of individual classifying variables as well as in the classification of an unknown subject. The only parameter required in this embodiment of the KNN scheme is k, the number of closest neighbors to examine in order to classify a data point. One other parameter that is included in some embodiments of the present invention is the fraction of nearest neighbors required to make a classification. One embodiment of the KNN algorithm uses an odd integer for k and classifies data points based on a simple majority of the k votes.

In practice, in embodiments where the physical variables measured from biological samples in the training population are mass spectrometry data, KNN is applied to each m/z index in the development dataset in order to determine if that m/z value can be used as an effective individual classifying variable. The following example describes the procedure for a single, exemplary m/z index. The output of this example is a single variable indicative of the strength of the ability of the m/z index alone to distinguish between two classes of subject (case and control). The steps described below are typically performed for all m/z indices in the data set, yielding an array of strength measurements that can be directly compared in order to determine the most discriminatory m/z indices. A subset of m/z measurements can thereby be selected and used as individual discriminatory variables. Although the example is specific to mass spectrometry data, data from other sources, such as microarray data could be used instead.

The development dataset and a screening algorithm (in this example, KNN) are used to determine the strength of a given m/z value as an individual classifying variable. For an exemplary m/z index, the data that is examined includes the mass-spec intensity values for all training set subjects at that particular m/z index and the clinical group (case or control) to which all subjects belong. In one preferred embodiment, the strength calculation proceeds as follows.

Step 202. Select a single data point (e.g., intensity value of a single m/z index) from one subject's data and isolate it from the remaining data. This data point will be the ‘unknown’ that is to be classified by the remaining points.

Step 204. Calculate the absolute value of the difference in intensity (or other measurement of the distance between data points) between the selected subject's data point and the intensity value from the same m/z index for each of the other subjects in the training dataset.

Step 206. Determine the k smallest intensity differences, the subjects from whom the associated k data points came, and the appropriate clinical group for those subjects.

Step 208. Determine the empirically-suggested clinical group for the selected datapoint (the “KNN indication”) indicated by a majority vote of the k-nearest neighbors' clinical groups. Alternatively derive the KNN indication through submajority or supermajority vote or through a weighted average voting scheme among the k nearest neighboring data points.

Step 210. Reveal the true subject class of the unknown subject and compare it to the KNN indication.

Step 212. Classify the KNN indication as a true positive (TP), true negative (TN), false positive (FP) or false negative (FN) result based on the comparison (“the KNN validation”).

Step 214. Repeat steps 202 through 212 using the value of the same single m/z index of each subject in the development dataset as the unknown, recording KNN validations as running counts of TN, TP, FN, and FP subjects.

Step 216. Using the TN, TP, FN, and FP measures, calculate the sensitivity (percent of case subjects that are correctly classified) and specificity (percent of control subjects that are correctly classified) of the individual m/z variable in distinguishing case from control subjects in the development dataset.

Step 218. Calculate one or more performance metrics from the sensitivity and specificity demonstrated by the m/z variable that represents the efficacy or strength of subject classification.

Step 212. Repeat steps 202 through 218 for all or a portion of the m/z variables measured in the dataset.

Another embodiment of this screening step makes use of a statistical hypothesis test whose output provides similar information about the strength of each individual variable as the class discriminator. In this second embodiment, the strength calculation proceeds as follows.

Step 302. Collect a set of all similarly measured variables (e.g., intensity values from the same m/z index) from all subject's data and separate the set into exhaustive, mutually exclusive subsets based on known subject class.

Step 304. Under the assumption of normally distributed data subsets, calculate distribution statistics (mean and standard deviation) for each subject class, thereby describing two theoretical class distributions for the measured variable.

Step 306. Determine a threshold that optimally separates the two theoretical distributions from each other.

Step 308. Using the determined threshold and metrics of TN, TP, FN, and FP, calculate the sensitivity and specificity of the individual m/z variable in distinguishing case from control subjects in the training dataset.

Step 310. Calculate one or more performance metrics from the sensitivity and specificity demonstrated by the m/z variable that represents the efficacy or strength of subject classification.

Step 312. Repeat steps 302 through 310 for each m/z variable measured.

Once the strengths of all individual classifying variables have been calculated and compiled, the most effective variables are selected for further analyses. This introduces the third parameter of the present embodiment—the number of individual discriminating variables to retain before beginning the process of defining intermediate combined classifiers. This parameter could alternatively, but with equal validity, be structured as an individual classifying variable strength cutoff below which individual classifying variables are retained.

### 5.3. Selection of Individual Discriminating Variables into a Subgroup for Use as a Intermediate Combined Classifier

Intermediate combined classifiers are an intermediate step in the process of macro classifier creation. Intermediate combined classifiers provide a means to identify otherwise hidden relationships within subject data, or to identify sub-groups of subjects in a supervised or unsupervised manner. In some embodiments, prior to combining individual discriminating variables into an intermediate combined classifier, each individual discriminating variable is quantized to a binary variable. In one embodiment, this is accomplished by replacing each continuous data point in an individual discriminating variable with its KNN indication. The result is an individual discriminating variable array made up of ones and zeros that indicate how the KNN approach classifies each subject in the training population.

In one embodiment of the present invention, there are at least three ways that individual discriminating variables can be organized into subgroups for use as intermediate combined classifiers: (i) based on spectral location (in the case of mass spectrometry data), (ii) similarity of expression among subjects in the training population, or (iii) through the use of pattern recognition algorithms. In the spectral location approach, m/z variables that are closely spaced in the m/z spectrum group together while those that are farther apart are segregated. In the similarity of expression approach, measurements are calculated as the correlation between subjects that were correctly (and/or incorrectly) classified by each m/z parameter. Variables that show high correlation are grouped together. In some embodiments, such correlation is 0.5 or greater, 0.6 or greater, 0.7 or greater, 0.8 or greater, 0.9 or greater, or 0.95 or greater. In the pattern recognition approach, machine learning and/or pattern recognition methods are used to train for the identification of individual variables that belong in each group. Such pattern recognition approaches include, but are not limited to, clustering, support vector machines, neural networks, principal component analysis, linear discriminant analysis, quadratic discriminant analysis, and decision trees.

In one embodiment of the invention, individual discriminating variable indices are first sorted, and then grouped into intermediate combined classifiers by the following algorithm:

Step 402. Begin with first and second individual discriminating variable indices.

Step 404. Measure the absolute value of the difference between the first and second individual discriminating variable indices.

Step 406. If the measured distance is less than or equal to a predetermined minimum index separation parameter, then group the two data points into a first intermediate combined classifier. If the measured distance is greater than the predetermined minimum index separation parameter, then the first value becomes the last index of one intermediate combined classifier and the second value begins another intermediated combined classifier.

Step 408. Step along individual discriminatory variable indices including each subsequent individual discriminatory variable in the current intermediate combined classifier until the separation between neighboring individual discriminatory variables exceeds the minimum index separation parameter. Each time this occurs, start a new intermediate combined classifier.

The above procedure combines individual discriminatory variables based on the similarity of their underlying physical measurements. Alternative embodiments group individual discriminatory variables into subgroups for use as intermediate combined classifiers based on the set of subjects that they are able to correctly classify on their own. In one example, the procedure for this alternative embodiment follows the following algorithm.

Step 502. Determine, for each individual discriminatory variable, the subset of subjects that are correctly classified by that variable alone.

Step 504. Calculate correlation coefficients reflecting the similarity between correctly classified subjects among all individual variables.

Step 506. Combine individual discriminatory variables into intermediate combined classifiers based on the correlation coefficients of individual discriminatory variables across the data set by ensuring that all individual discriminatory variables that are combined into a common intermediate combined classifier are correlated above some threshold (e.g., 0.5 or greater, 0.6 or greater, 0.7 or greater, 0.8 or greater, 0.9 or greater, or 0.95 or greater).

### 5.4. Collapsing Individual Discriminating Variables in an Intermediate Combined Classifier into a Single Value

Each intermediate combined classifier is, by itself, a multivariate set of data observed from the same set of subjects. Intermediate combined classifiers can be of at least two major types. Type I intermediate combined classifiers are those that contain individual discriminating variables that code for a similar trait and therefore could be combined into a single variable to represent that trait. Type II intermediate combined classifiers are those containing individual discriminating variables that code for different traits within which there are identifiable patterns that can classify subjects. Either type is collapsed in some embodiments of the present invention by combining the individual discriminating variables within the intermediate combined classifier into a single variable. This collapse is done so that intermediate combined classifiers can be combined in order to form a meta classifier.

Type II intermediate combined classifiers can be collapsed using algorithms such as pattern matching, machine learning, or artificial neural networks. In some embodiments, use of such techniques provides added information or improved performance and is within the scope of the present invention. Exemplary neural networks that can be used for this purpose are described in Section 5.9, below. In one preferred embodiment, individual discriminatory variables are grouped into intermediate combined classifiers based on their similar location in the multivariate spectra.

In some embodiments, the individual discriminatory variables in an intermediate combined classifier of type I are collapsed using a normalized weighted sum of the individual discriminatory variable's data points. Prior to summing, such data points are optionally weighted by a normalized measure of their classification strength for that individual classifying variable. Individual classifying variables that are more effective receive a stronger weight. Normalization is linear and achieved by ensuring that the weights among all individual discriminatory variables in each intermediate combined classifier sum to unity. After the individual classifying variables are weighted and summed, the cutoff by which to distinguish between two classes or subclasses from the resulting intermediate combined classifier is determined. In one embodiment, the intermediate combined classifier cutoff is determined as the value that minimizes the distance (e.g., Euclidian distance) from perfect performance (sensitivity=specificity=1) to actual performance as measured by sensitivity and specificity. Finally, the intermediate combined classifier data points are also quantized to one-bit accuracy by assigning those greater than the cutoff a value of one and those below the cutoff a value of zero. The following algorithm is used in some embodiments of the present invention.

Step 602. Weight each individual discriminating variable within an intermediate combined classifier by a normalized measure of its individual classification strength.

Step 604. Sum all weighted individual discriminatory variables to generate a single intermediate combined classifier set of data points.

Step 606. Determine the cutoff for each intermediate combined classifier for classification of the training dataset.

Step 608. Quantize the intermediate combined classifier data points to binary precision.

Alternative embodiments employ algorithmic techniques other than a normalized weighted sum in order to combine the individual discriminatory variables within an intermediate combined classifier into a single variable. Alternative embodiments include, but are not limited to, linear discriminatory analysis (Section 5.10), quadratic discriminant analysis (Section 5.11), artificial neural networks (Section 5.9), linear regression (Hastie et al., 2001, The Elements of Statistical Learning: Data Mining, Inference, and Prediction, Springer, N.Y., hereby incorporated by reference), logarithmic regression, logistic regression (Agresti, 1996, An Introduction to Categorical Data Analysis, John Wiley & Sons, New York, hereby incorporated by reference in its entirety) and/or support vector machine algorithms (Section 5.12), among others.

### 5.5. Combining Intermediate Combined Classifiers into a Meta Classifier

The process of combining multiple intermediate combined classifiers into a single meta classifier in one preferred embodiment is directly analogous to the step of collapsing several individual discriminatory variables into a single intermediate combined classifier. First, each binary intermediate combined classifier is weighted by normalized measurement of its classification strength, typically a function of each intermediate combined classifier's sensitivity and specificity against the training dataset. In some embodiments, all strength values are normalized by forcing them to sum to one. A classification cutoff is determined based on actual performance and the weighted sum is quantized to binary precision using that cutoff.

This final set of binary data points is the meta classifier for the training population. The variables created in the process of forming the meta classifier, including the original training data for all included individual discriminating variables, the true clinical group for all subjects in the training dataset, and all weighting factors and thresholds that dictate how individual discriminating variables are combined into intermediate combined classifiers and intermediate combined classifiers are combined into a meta classifier, serve as the basis for the classification of unknown spectra described below. This collection of values becomes the model by which additional datasets from samples not in the training dataset can be classified.

### 5.6. Using a Meta Classifier to Classify a Subject not in the Training Population

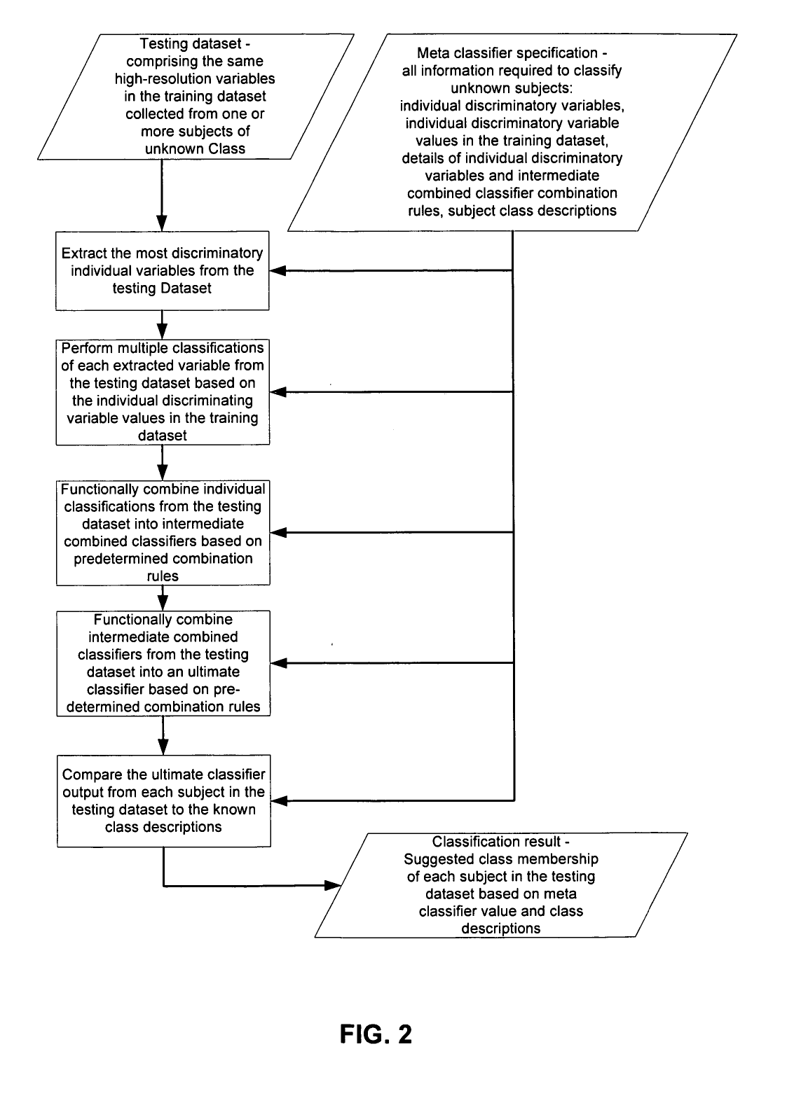

The present invention further includes a method of using the meta classifier, which has been deterministically calculated based upon the training population using the techniques described herein, to classify a subject not in the training population. An example of such a method is illustrated in FIG. 2. Such subjects can be in the validation dataset, either in the case or control groups. The steps for accomplishing this task, in one embodiment of the present invention, are very similar to the steps for forming the meta classifier. In this case, however, all meta classifier variables are known (e.g., stored) and can be applied directly to calculate the assignment or classification of the subject not in the training population. In some embodiments, there are a suite of meta classifiers, where each meta classifier is trained to detect a specific subset of disease characteristics or a multiplicity of distinct diseases.

First, in a preferred embodiment, the unknown subjects' mass spectra are reduced to include only those m/z indices that correspond to each of the individual discriminating variables that were retained in the diagnostic model. Each of the resulting m/z index intensity values (physical variables) from the unknown subjects is then subjected to the KNN procedure and assigned a KNN indication of either case or control using the training population samples for each individual classifying variable. In some embodiments, some form of classifying algorithm other than KNN incorporating the training population data is used to assign an indication of either case or control to each of the measured physical variables of the biological sample from the unknown subject. In preferred embodiments, the same form of classifying algorithm that was used to identify the individual discriminating variables used to build the original meta classifier is used. Thus, if KNN was used to identify individual discriminating variables in the original development of the meta classifier, KNN is used to classify the physical variables measured from a biological sample taken from the subject whose subject class is presently unknown. The result of this step is a binary set of individual discriminating variable expressions for the unknown subject. In other embodiments, the type of data collected for the unknown subject is a form of data other than mass spectral data such as, for example, microarray data. In such alternative embodiments, each physical variable in the raw data (e.g., gene abundance values) is subjected to a classifying algorithm (e.g., KNN, t-test, ANOVA, etc.) and assigned an indication of either case or control using the training population data.

Next, the unknown subject's individual discriminating variables are collapsed into one or more binary intermediate combined classifiers. This step utilizes the intermediate combined classifier grouping information, individual discriminating variable strength measurements, and the optimal intermediate combined classifier expression cutoff. All of these variables are determined and stored during training dataset analysis. Finally, each intermediate combined classifier strength measurement and the optimal meta classifier cutoff threshold is used to combine the intermediate combined classifiers into a single, binary meta classifier expression value. This value serves as the classification output for the unknown subject.

### 5.7. Computer Embodiments

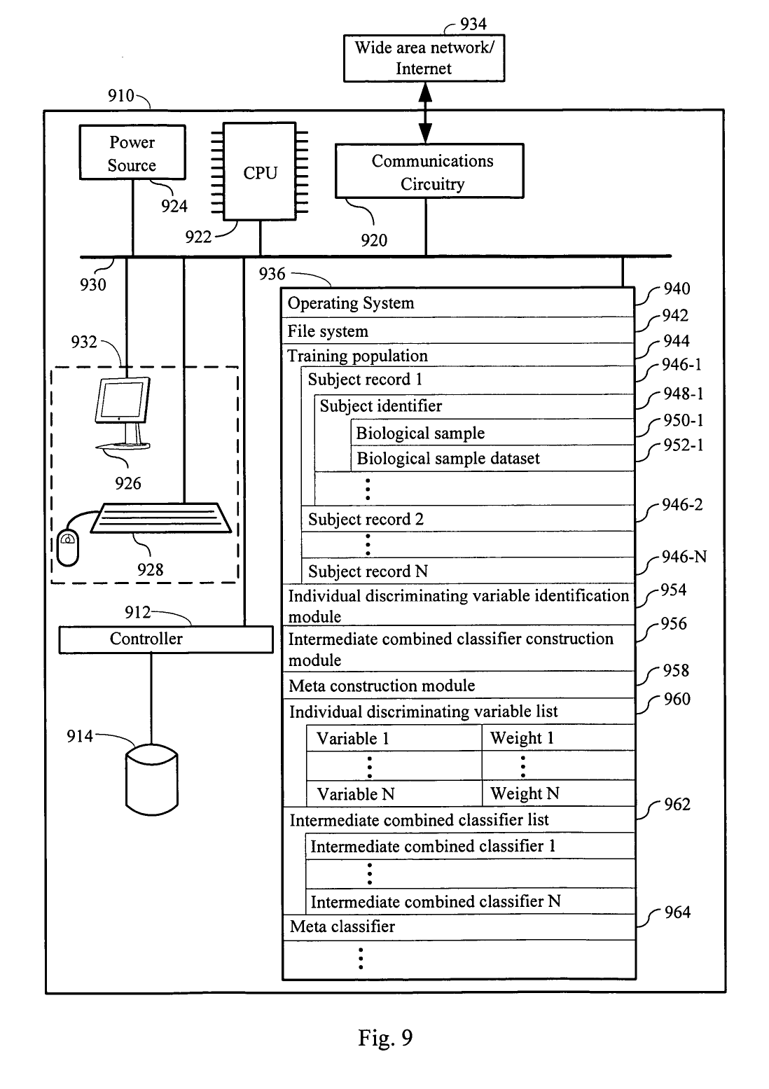

FIG. 9 details, in one embodiment of the present invention, an exemplary system that supports the functionality described above. The system is preferably a computer system 910 comprising:
one or more central processors 922;
a main non-volatile storage unit 914, for example a hard disk drive, for storing software and data, the storage unit 914 controlled by storage controller 912;
a system memory 936, preferably high speed random-access memory (RAM), for storing system control programs, data, and application programs, comprising programs and data loaded from non-volatile storage unit 914; system memory 936 may also include read-only memory (ROM);
an optional user interface 932, comprising one or more input devices (e.g., keyboard 928) and a display 926 or other output device;
an optional network interface card 920 for connecting to any wired or wireless communication network 934 (e.g., a wide area network such as the Internet);
an internal bus 930 for interconnecting the aforementioned elements of the system; and
a power source 924 to power the aforementioned elements.

Operation of computer 910 is controlled primarily by operating system 940, which is executed by central processing unit 922. Operating system 940 can be stored in system memory 936. In addition to operating system 940, in a typical implementation, system memory 936 includes various components described below. Those of skill in the art will appreciate that such components can be wholly resident in RAM 936 or non-volatile storage unit 914. Furthermore, at any given time, such components can partially reside both in RAM 936 and non-volatile storage unit 914. Further still, some of the components illustrated in FIG. 9 as resident in RAM 936 can be resident in another computer (e.g., a remote computer that is addressable by computer 910 over wide area network 934) or another computer in the same room as computer 910 that is in electrical communication with computer 910. As illustrated in FIG. 9, in one exemplary embodiment of the invention, RAM 936 comprises:
file system 942 for controlling access to the various files and data structures used by the present invention;
a training population 944 used as a basis for selection of individual discriminating variables, intermediate combined classifiers, and macro classifiers in accordance with the methods of the present invention;
an individual discriminating variable identification module 954 for identifying individual discriminating variables;
an intermediate combined classifier construction module 956 for constructing intermediate combined classifiers from individual discriminating variables in accordance with embodiments of the present invention;
a macro classifier construction module 958 for constructing macro classifiers from intermediate combined classifiers;

Training population 944 comprises a plurality of subjects 946. For each subject 946, there is a subject identifier 948 that indicates a subject class for the subject and other identifying data. One or more biological samples are obtained from each subject 946 as described above. Each such biological sample is tracked by a corresponding biological sample 950 data structure. For each such biological sample, a biological sample dataset 952 is obtained and stored in computer 910 (or a computer addressable by computer 910). Representative biological sample datasets 952 include, but are not limited to, sample datasets obtained from mass spectrometry analysis of biological samples as well as nucleic acid microarray analysis of such biological samples.

Individual discriminating variable identification module 954 is used to analyze each dataset 952 in order to identify variables that discriminate between the various subject classes represented by the training population. In preferred embodiments, individual discriminating variable identification module 954 assigns a weight to each individual discriminating variable that is indicative of the ability of the individual discriminating variable to discriminate subject classes. In some embodiments, such individual discriminating variables and their corresponding weights are stored in memory 936 as an individual discriminating variable list 960. In preferred embodiments, intermediate combined classifier construction module 956 constructs intermediate combined classifiers from groups of individual discriminating variables selected from individual discriminating variable list 960. In some embodiments, such intermediate combined classifiers are stored in intermediate combined classifier list 962. In preferred embodiments, meta construction module 958 constructs a meta classifier from the intermediate combined classifiers. In some embodiments, this meta classifier is stored in computer 910 as classifier 964.

An advantage of the approach illustrated here is that it is possible to project back from the meta classifier to determine the underlying chemical or physical basis for disease discrimination. This allows for the ability to develop or improve therapies and to direct basic research from the generated solutions and expands the utility of the solutions identified ito beyond just diagnostic applications.

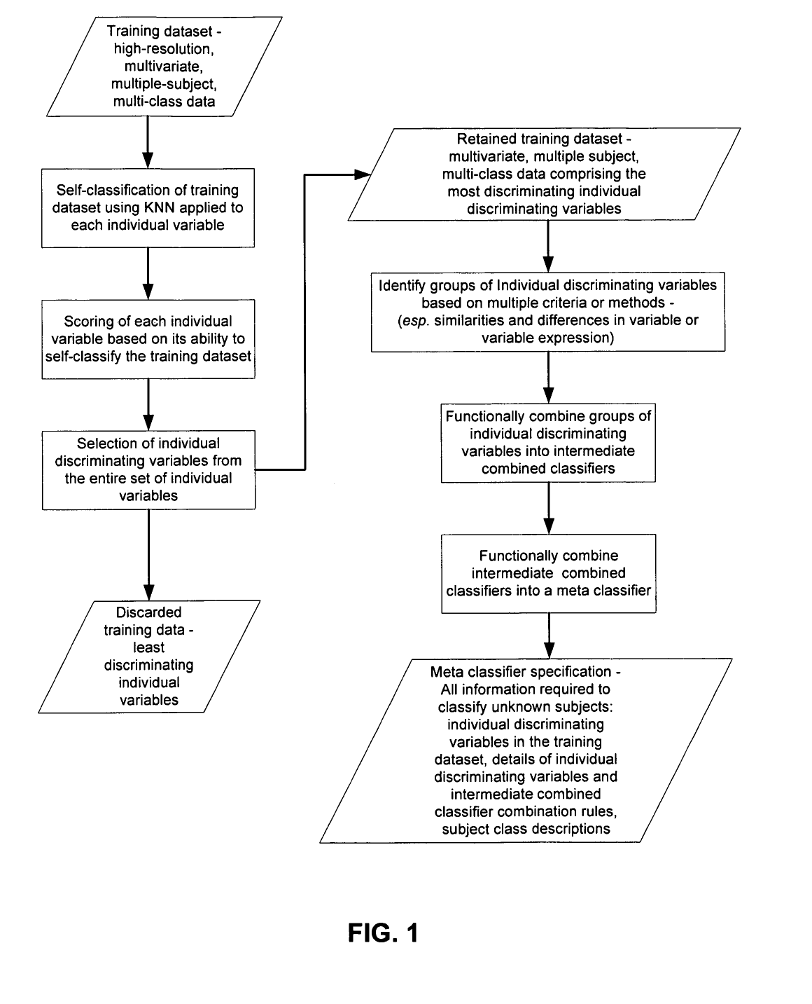

As illustrated in FIG. 1, computer 910 comprises software program modules and data structures. The data structures and software program modules either stored in computer 910 or are accessible to computer 910 include a training population 944, individual discriminating variable identification module 954, intermediate combined classifier construction module 956, meta construction module 958, individual discriminating variable list 960, intermediate combined classifier list 962, and meta classifier 964. Each of the aforementioned data structures can comprise any form of data storage system including, but not limited to, a flat ASCII or binary file, an Excel spreadsheet, a relational database (SQL), or an on-line analytical processing (OLAP) database (MDX and/or variants thereof).

In some embodiments, each of the data structures stored or accessible to system 910 are single data structures. In other embodiments, such data structures in fact comprise a plurality of data structures (e.g., databases, files, archives) that may or may not all be hosted by the same computer 910. For example, in some embodiments, training population 944 comprises a plurality of Excel spreadsheets that are stored either on computer 910 and/or on computers that are addressable by computer 910 across wide area network 934. In another example, individual discriminating list 960 comprises a database that is either stored on computer 910 or is distributed across one or more computers that are addressable by computer 910 across wide area network 934.

### 5.8. Exemplary Clustering Techniques

The subsections below describe exemplary methods for clustering that can be used in, for example, step 108 that is described in Section 5.1. In these techniques, the values for physical variables are treated as a vector across the training data set and these vectors are clustered based on degree of similarity. More information on clustering techniques can be found in Kaufman and Rousseeuw, 1990, Finding Groups in Data: An Introduction to Cluster Analysis, Wiley, New York, N.Y.; Everitt, 1993, Cluster analysis (3d ed.), Wiley, New York, N.Y.; Backer, 1995, Computer-Assisted Reasoning in Cluster Analysis, Prentice Hall, Upper Saddle River, N.J.; and Duda et al., 2001, Pattern Classification, John Wiley & Sons, New York, N.Y.; Draghici, 2003, Data Analysis Tools for DNA Microarrays, Chapman & Hall, CRC Press London, Chapter 11, each of which is hereby incorporated by reference in its entirety. Although not described below, additional clustering techniques that can be used in the methods of the present invention include, but are not limited to, Kohonen maps or self-organizing maps. See for, example, Draghici, 2003, Data Analysis Tools for DNA Microarrays, Chapman & Hall, CRC Press London, Section 11.3.3, which is hereby incorporated by reference in its entirety.

### 5.8.1. Hierarchical Clustering Techniques

Hierarchical cluster analysis is a statistical method for finding relatively homogenous clusters of elements based on measured characteristics. Consider a sequence of partitions of n samples into c clusters. The first of these is a partition into n clusters, each cluster containing exactly one sample. The next is a partition into n−1 clusters, the next is a partition into n-2, and so on until the n^{th}, in which all the samples form one cluster. Level k in the sequence of partitions occurs when c=n−k+1. Thus, level one corresponds to n clusters and level n corresponds to one cluster. Given any two samples x and x*, at some level they will be grouped together in the same cluster. If the sequence has the property that whenever two samples are in the same cluster at level k they remain together at all higher levels, then the sequence is said to be a hierarchical clustering. Duda et al., 2001, Pattern Classification, John Wiley & Sons, New York, 2001: 551.

### 5.8.1.1. Agglomerative Clustering

In some embodiments, the hierarchical clustering technique used is an agglomerative clustering procedure. Agglomerative (bottom-up clustering) procedures start with n singleton clusters and form a sequence of partitions by successively merging clusters. The major steps in agglomerative clustering are contained in the following procedure, where c is the desired number of final clusters, Dᵢ and Dⱼ are clusters, xᵢ is a individual discriminating variable vector (e.g., each value for a given individual discriminating variable from each member of the training population), and there are n such vectors:

| | |
|---|---|
| 1 | begin initialize c, ĉ [symbol] n, Dᵢ{xᵢ}, i = 1, ..., n |

| | |
|---|---|
| 2 | do ĉ [symbol] ĉ −1 |

| | |
|---|---|
| 3 | find nearest clusters, say, Dᵢ and Dⱼ |
| 4 | merge Dᵢ and Dⱼ |

| | |
|---|---|
| 5 | until c = ĉ |

| | |
|---|---|
| 6 | return c clusters |

| | |
|---|---|
| 7 | end |

In this algorithm, the terminology a←b assigns to variable a the new value b. As described, the procedure terminates when the specified number of clusters has been obtained and returns the clusters as a set of points. A key point in this algorithm is how to measure the distance between two clusters Dᵢ and Dⱼ. The method used to define the distance between clusters Dᵢ and Dⱼ defines the type of agglomerative clustering technique used. Representative techniques include the nearest-neighbor algorithm, farthest-neighbor algorithm, the average linkage algorithm, the centroid algorithm, and the sum-of-squares algorithm.

Nearest-neighbor algorithm. The nearest-neighbor algorithm uses the following equation to measure the distances between clusters:

$$d min ( Di , Dj ) = {{min}_{x ∈ Di}}_{{x}^{′} ∈ Dj} ‖ x - {x}^{′} ‖ .$$

This algorithm is also known as the minimum algorithm. Furthermore, if the algorithm is terminated when the distance between nearest clusters exceeds an arbitrary threshold, it is called the single-linkage algorithm. Consider the case in which the data points are nodes of a graph, with edges forming a path between the nodes in the same subset Dᵢ. When dmin( ) is used to measure the distance between subsets, the nearest neighbor nodes determine the nearest subsets. The merging of Dᵢ and Dⱼ corresponds to adding an edge between the nearest pair of nodes in Dᵢ and Dⱼ. Because edges linking clusters always go between distinct clusters, the resulting graph never has any closed loops or circuits; in the terminology of graph theory, this procedure generates a tree. If it is allowed to continue until all of the subsets are linked, the result is a spanning tree. A spanning tree is a tree with a path from any node to any other node. Moreover, it can be shown that the sum of the edge lengths of the resulting tree will not exceed the sum of the edge lengths for any other spanning tree for that set of samples. Thus, with the use of dmin( ) as the distance measure, the agglomerative clustering procedure becomes an algorithm for generating a minimal spanning tree. See Duda et al., id, pp. 553-554.

Farthest-neighbor algorithm. The farthest-neighbor algorithm uses the following equation to measure the distances between clusters:

$$d max ( Di , Dj ) = {{max}_{x ∈ Di}}_{{x}^{′} ∈ Dj} ‖ x - {x}^{′} ‖ .$$

This algorithm is also known as the maximum algorithm. If the clustering is terminated when the distance between the nearest clusters exceeds an arbitrary threshold, it is called the complete-linkage algorithm. The farthest-neighbor algorithm discourages the growth of elongated clusters. Application of this procedure can be thought of as producing a graph in which the edges connect all of the nodes in a cluster. In the terminology of graph theory, every cluster contains a complete subgraph. The distance between two clusters is terminated by the most distant nodes in the two clusters. When the nearest clusters are merged, the graph is changed by adding edges between every pair of nodes in the two clusters.

Average linkage algorithm. Another agglomerative clustering technique is the average linkage algorithm. The average linkage algorithm uses the following equation to measure the distances between clusters:

$${d}_{avg} ( Di , Dj ) = \frac{1}{{n}_{i} {n}_{j}} {\sum }_{x ∈ Di} {\sum }_{{x}^{′} ∈ Dj} ‖ x - {x}^{′} ‖ .$$

Hierarchical cluster analysis begins by making a pair-wise comparison of all individual discriminating variable vectors in a set of such vectors. After evaluating similarities from all pairs of elements in the set, a distance matrix is constructed. In the distance matrix, a pair of vectors with the shortest distance (i.e. most similar values) is selected. Then, when the average linkage algorithm is used, a “node” (“cluster”) is constructed by averaging the two vectors. The similarity matrix is updated with the new “node” (“cluster”) replacing the two joined elements, and the process is repeated n-1 times until only a single element remains. Consider six elements, A-F having the values:
A{4.9}, B{8.2}, C{3.0}, D{5.2}, E{8.3}, F{2.3}.
   In the first partition, using the average linkage algorithm, one matrix (sol. 1) that could be computed is:
(sol. 1) A {4.9}, B-E{8.25}, C{3.0}, D{5.2}, F{2.3}.
   Alternatively, the first partition using the average linkage algorithm could yield the matrix:
(sol. 2) A {4.9}, C{3.0}, D{5.2}, E-B{8.25}, F{2.3}.

Assuming that solution 1 was identified in the first partition, the second partition using the average linkage algorithm will yield:
(sol. 1-1) A-D{5.05}, B-E{8.25}, C{3.0}, F{2.3} or
(sol. 1-2) B-E{8.25}, C{3.0}, D-A{5.05}, F{2.3}.

Assuming that solution 2 was identified in the first partition, the second partition of the average linkage algorithm will yield:
(sol. 2-1) A-D{5.05}, C{3.0}, E-B{8.25}, F{2.3} or
(sol. 2-2) C{3.0}, D-A{5.05}, E-B{8.25}, F{2.3}.
   Thus, after just two partitions in the average linkage algorithm, there are already four matrices. See Duda et al., Pattern Classification, John Wiley & Sons, New York, 2001, p. 551.

### 5.8.1.2. Clustering with Pearson Correlation Coefficients

In one embodiment of the present invention, agglomerative hierarchical clustering with Pearson correlation coefficients is used. In this form of clustering, similarity is determined using Pearson correlation coefficients between the physical variable vector pairs. Other metrics that can be used, in addition to the Pearson correlation coefficient, include but are not limited to, a Euclidean distance, a squared Euclidean distance, a Euclidean sum of squares, a Manhattan distance, a Chebychev distance, Angle between vectors, a correlation distance, Standardized Euclidean distance, Mahalanobis distance, a squared Pearson correlation coefficient, or a Minkowski distance. Such metrics can be computed, for example, using SAS (Statistics Analysis Systems Institute, Cary, N.C.) or S-Plus (Statistical Sciences, Inc., Seattle, Wash.). Such metrics are described in Draghici, 2003, Data Analysis Tools for DNA Microarrays, Chapman & Hall, CRC Press London, chapter 11, which is hereby incorporated by reference.

### 5.8.1.3. Divisive Clustering

In some embodiments, the hierarchical clustering technique used is a divisive clustering procedure. Divisive (top-down clustering) procedures start with all of the samples in one cluster and form the sequence by successfully splitting clusters. Divisive clustering techniques are classified as either a polythetic or a monthetic method. A polythetic approach divides clusters into arbitrary subsets.

### 5.8.2. K-Means Clustering

In k-means clustering, sets of physical variable vectors are randomly assigned to K user specified clusters. The centroid of each cluster is computed by averaging the value of the vectors in each cluster. Then, for each i=1, . . . , N, the distance between vector xᵢ and each of the cluster centroids is computed. Each vector xᵢ is then reassigned to the cluster with the closest centroid. Next, the centroid of each affected cluster is recalculated. The process iterates until no more reassignments are made. See Duda et al., 2001, Pattern Classification, John Wiley & Sons, New York, N.Y., pp. 526-528. A related approach is the fuzzy k-means clustering algorithm, which is also known as the fuzzy c-means algorithm. In the fuzzy k-means clustering algorithm, the assumption that every individual discriminating variable vector is in exactly one cluster at any given time is relaxed so that every vector (or set) has some graded or “fuzzy” membership in a cluster. See Duda et al., 2001, Pattern Classification, John Wiley & Sons, New York, N.Y., pp. 528-530.

### 5.8.3. Jarvis-Patrick Clustering

Jarvis-Patrick clustering is a nearest-neighbor non-hierarchical clustering method in which a set of objects is partitioned into clusters on the basis of the number of shared nearest-neighbors. In the standard implementation advocated by Jarvis and Patrick, 1973, IEEE Trans. Comput., C-22:1025-1034, a preprocessing stage identifies the K nearest-neighbors of each object in the dataset. In the subsequent clustering stage, two objects i and j join the same cluster if (i) i is one of the K nearest-neighbors of j, (ii) j is one of the K nearest-neighbors of i, and (iii) i and j have at least kₘᵢₙ of their K nearest-neighbors in common, where K and kₘᵢₙ are user-defined parameters. The method has been widely applied to clustering chemical structures on the basis of fragment descriptors and has the advantage of being much less computationally demanding than hierarchical methods, and thus more suitable for large databases. Jarvis-Patrick clustering can be performed using the Jarvis-Patrick Clustering Package 3.0 (Barnard Chemical Information, Ltd., Sheffield, United Kingdom).

### 5.9. Neural Networks

A neural network has a layered structure that includes, at a minimum, a layer of input units (and the bias) connected by a layer of weights to a layer of output units. Such units are also referred to as neurons. For regression, the layer of output units typically includes just one output unit. However, neural networks can handle multiple quantitative responses in a seamless fashion by providing multiple units in the layer of output units.

In multilayer neural networks, there are input units (input layer), hidden units (hidden layer), and output units (output layer). There is, furthermore, a single bias unit that is connected to each unit other than the input units. Neural networks are described in Duda et al., 2001, Pattern Classification, Second Edition, John Wiley & Sons, Inc., New York; and Hastie et al., 2001, The Elements of Statistical Learning, Springer-Verlag, New York.

The basic approach to the use of neural networks is to start with an untrained network. A training pattern is then presented to the untrained network. This training pattern comprises a training population and, for each respective member of the training population, an association of the respective member with a specific trait subgroup. Thus, the training pattern specifies one or more measured variables as well as an indication as to which subject class each member of the training population belongs. In preferred embodiments, training of the neural network is best achieved when the training population includes members from more than one subject class.

In the training process, individual weights in the neural network are seeded with arbitrary weights and then the measured data for each member of the training population is applied to the input layer. Signals are passed through the neural network and the output determined. The output is used to adjust individual weights. A neural network trained in this fashion classifies each individual of the training population with respect to one of the known subject classes. In typical instances, the initial neural network does not correctly classify each member of the training population. Those individuals in the training population that are misclassified identify and determine an error or criterion function for the initial neural network. This error or criterion function is some scalar function of the trained neural network weights and is minimized when the network outputs match the desired outputs. In other words, the error or criterion function is minimized when the network correctly classifies each member of the training population into the correct trait subgroup. Thus, as part of the training process, the neural network weights are adjusted to reduce this measure of error. For regression, this error can be sum-of-squared errors. For classification, this error can be either squared error or cross-entropy (deviation). See, e.g., Hastie et al., 2001, The Elements of Statistical Learning, Springer-Verlag, New York. Those individuals of the training population that are still incorrectly classified by the trained neural network, once training of the network has been completed, are identified as outliers and can be removed prior to proceeding.

### 5.10. Linear Discriminant Analysis

Linear discriminant analysis (LDA) attempts to classify a subject into one of two categories based on certain object properties. In other words, LDA tests whether object attributes measured in an experiment predict categorization of the objects. LDA typically requires continuous independent variables and a dichotomous categorical dependent variable. In the present invention, the measured values for the individual discriminatory variables across the training population serve as the requisite continuous independent variables. The subject class of each of the members of the training population serves as the dichotomous categorical dependent variable.

LDA seeks the linear combination of variables that maximizes the ratio of between-group variance and within-group variance by using the grouping information. Implicitly, the linear weights used by LDA depend on how the measured values of the individual discriminatory variable across the training set separates in two groups (e.g., the group that is characterized as members of a first subject class and a group that is characterized as members of a second subject class) and how these measured values correlate with the measured values of other intermediate combined classifiers across the training population. In some embodiments, LDA is applied to the data matrix of the N members in the training population by K individual discriminatory variables. Then, the linear discriminant of each member of the training population is plotted. Ideally, those members of the training population representing a first subgroup (e.g. subjects in a first subject classification) will cluster into one range of linear discriminant values (e.g., negative) and those member of the training population representing a second subgroup (e.g. those subjects in a second subject classification) will cluster into a second range of linear discriminant values (e.g., positive). The LDA is considered more successful when the separation between the clusters of discriminant values is larger. For more information on linear discriminant analysis, see Duda, Pattern Classification, Second Edition, 2001, John Wiley & Sons, Inc; and Hastie, 2001, The Elements of Statistical Learning, Springer, N.Y.; Venables & Ripley, 1997, Modern Applied Statistics with s-plus, Springer, N.Y.

### 5.11. Quadratic Discriminant Analysis

Quadratic discriminant analysis (QDA) takes the same input parameters and returns the same results as LDA. QDA uses quadratic equations, rather than linear equations, to produce results. LDA and QDA are interchangeable, and which to use is a matter of preference and/or availability of software to support the analysis. Logistic regression takes the same input parameters and returns the same results as LDA and QDA.

### 5.12. Support Vector Machines

In some embodiments of the present invention, support vector machines (SVMs) are used to classify subjects. SVMs are a relatively new type of learning algorithm. See, for example, Cristianini and Shawe-Taylor, 2000, An Introduction to Support Vector Machines, Cambridge University Press, Cambridge, Boser et al., 1992, “A training algorithm for optimal margin classifiers, in Proceedings of the 5^{th} Annual ACM Workshop on Computational Learning Theory, ACM Press, Pittsburgh, Pa., pp. 142-152; and Vapnik, 1998, Statistical Learning Theory, Wiley, New York, each of which is hereby incorporated by reference in its entirety. When used for classification, SVMs separate a given set of binary labeled training data with a hyper-plane that is maximally distant from them. For cases in which no linear separation is possible, SVMs can work in combination with the technique of ‘kernels’, which automatically realizes a non-linear mapping to a feature space. The hyper-plane found by the SVM in feature space corresponds to a non-linear decision boundary in the input space.

In one approach, when a SVM is used, the individual discriminating variables are standardized to have mean zero and unit variance and the members of a training population are randomly divided into a training set and a test set. For example, in one embodiment, two thirds of the members of the training population are placed in the training set and one third of the members of the training population are placed in the test set. The values for a combination of individual discriminating variables are used to train the SVM. Then the ability for the trained SVM to correctly classify members in the test set is determined. In some embodiments, this computation is performed several times for a given combination of individual discriminating variables. In each iteration of the computation, the members of the training population are randomly assigned to the training set and the test set. Then, the quality of the combination of individual discriminating values is taken as the average of each such iteration of the SVM computation. For more information on SVMs, see Duda, Pattern Classification, Second Edition, 2001, John Wiley & Sons, Inc.; Hastie, 2001, The Elements of Statistical Learning, Springer, N.Y.; and Furey et al., 2000, Bioinformatics 16, 906-914, each of which is incorporated by reference in its entirety.

### 5.13. Exemplary Subject Classes

Exemplary subject classes of the systems and methods of the present invention can be used to discriminate include the presence, absence, or specific defined states of any disease, including but not limited to asthma, cancers, cerebrovascular disease, common late-onset Alzheimer's disease, diabetes, heart disease, hereditary early-onset Alzheimer's disease (George-Hyslop et al., 1990, Nature 347: 194), hereditary nonpolyposis colon cancer, hypertension, infection, maturity-onset diabetes of the young (Barbosa et al., 1976, Diabete Metab. 2: 160), mellitus, nonalcoholic fatty liver (NAFL) (Younossi, et al., 2002, Hepatology 35, 746-752), nonalcoholic steatohepatitis (NASH) (James & Day, 1998, J. Hepatol. 29: 495-501), non-insulin-dependent diabetes mellitus, and polycystic kidney disease (Reeders et al., 1987, Human Genetics 76: 348).

Cancers that can be identified in accordance with the present invention include, but are not limited to, human sarcomas and carcinomas, e.g., fibrosarcoma, myxosarcoma, liposarcoma, chondrosarcoma, osteogenic sarcoma, chordoma, angiosarcoma, endotheliosarcoma, lymphangiosarcoma, lymphangioendotheliosarcoma, synovioma, mesothelioma, Ewing's tumor, leiomyosarcoma, rhabdomyosarcoma, colon carcinoma, pancreatic cancer, breast cancer, ovarian cancer, prostate cancer, squamous cell carcinoma, basal cell carcinoma, adenocarcinoma, sweat gland carcinoma, sebaceous gland carcinoma, papillary carcinoma, papillary adenocarcinomas, cystadenocarcinoma, medullary carcinoma, bronchogenic carcinoma, renal cell carcinoma, hepatoma, bile duct carcinoma, choriocarcinoma, seminoma, embryonal carcinoma, Wilms' tumor, cervical cancer, testicular tumor, lung carcinoma, small cell lung carcinoma, bladder carcinoma, epithelial carcinoma, glioma, astrocytoma, medulloblastoma, craniopharyngioma, ependymoma, pinealoma, hemangioblastoma, acoustic neuroma, oligodendroglioma, meningioma, melanoma, neuroblastoma, retinoblastoma; leukemias, e.g., acute lymphocytic leukemia and acute myelocytic leukemia (myeloblastic, promyelocytic, myelomonocytic, monocytic and erythroleukemia); chronic leukemia (chronic myelocytic (granulocytic) leukemia and chronic lymphocytic leukemia); and polycythemia vera, lymphoma (Hodgkin's disease and non-Hodgkin's disease), multiple myeloma, Waldenström's macroglobulinemia, and heavy chain disease.

### 6. EXAMPLE

In the following example, the methods described in Section 5 are applied to mass spectral data derived from individuals with and without both ovarian and prostate cancers. In the following example, step numbers are used. These step numbers refer to the corresponding step numbers provided in Section 5.1. The steps described in this example serve as an example of the corresponding step numbers in Section 5.1. As such, the description provided in this section merely provides an example of such steps and by no means serves to limit the scope of the corresponding steps in Section 5.1. Furthermore, the steps outlined in the following example correspond to the steps illustrated in FIG. 1.

### 6.1. Subjects and Data

Steps 102-104—obtaining access to data descriptive of a number of samples in a training population and quantified physical variables from each sample in the training population. The data used for this work is from the FDA-NCI Clinical Proteomics Program Databank. All raw data files along with descriptions of included subjects, sample collection procedures, and sample analysis methods are available from the NCI Clinical Proteomics Program website as of Feb. 21, 2005 at http://home.ccr.cancer.gov/ncifdaproteomics/ppatterns.asp, which is hereby incorporated by reference in its entirety. The current analysis made use of two available NCI Clinical Proteomics datasets available from the NCI at this web site. The first, the 08-07-02 Ovarian Cancer dataset, which is hereby incorporated by reference in its entirety, consists of surface-enhanced laser desorption and ionisation time-of-flight (SELDI-TOF) (Ciphergen Biosystems, Freemont, Calif.) mass spectrometer datasets of 253 female subjects—162 with clinically confirmed ovarian cancer and 91 high-risk individuals that are ovarian cancer free. To construct the 08-07-02 Ovarian Cancer dataset, the methods of Petricoin III et al., 2002, The Lancet 359, pp. 572-577, hereby incorporated by reference in its entirety, were repeated using a WCX2 chip rather than a H4 chip. The samples were processed by hand and the baseline was subtracted creating the negative intensities seen for some values. The second dataset used in the present example, a subset of the 07-03-02 Prostate Cancer Dataset, hereby incorporated by reference in its entirety, included 63 normal subjects and 43 subjects with elevated PSA levels and clinically confirmed prostate cancer. This data was collected using the H4 protein chip and a Ciphergen PBS1 SELDI-TOF mass spectrometer. The chip was prepared by hand using the manufacturer recommended protocol. The spectra were exported with the baseline subtracted.

The mass spectrometry data used in this study consist of a single, low-molecular weight proteomic mass spectrum for each tested subject. Each spectrum is a series of intensity values measured as a function of each ionic species' mass-to-charge (m/z) ratio. Molecular weights up to approximately 20,000 Daltons are measured and reported as intensities in 15,154 unequally spaced m/z bins. Data available from the NCI website comprises mass spectral analysis of the serum from multiple subjects, some of which are known to have cancer and are identified as such. Each mass spectrometry dataset was separated into a training population (80% each of case and control subjects) and a testing population (20% each of case and control subjects) sets through randomized selection.

### 6.2. Identification of Individual Discriminatory Variables

Step 106—screening the quantifiable physical variables obtained in step 104 in order to identify individual discriminating variables. Given the broad range of normal levels of various biochemical components in serum, the potential for co-existing pathologies, and the variability in disease presentation, it is extremely unlikely that any single proteomic biomarker will accurately identify all disease subjects. It is also reasonable to assume that the most effective markers of disease may be relative expression measures created from a composite of individual mass spectral intensity values. In order to address these issues, the efficacy of every available variable or feature was assessed. This was accomplished by scanning through each of the hundreds of thousands of mass-spec intensity values in the above-described datasets in order to determine the small subset that can best contribute to a diagnostic proteomic profile. The individual diagnostic variables or biomarkers that are retained at this step are called individual discriminating variables.

While a number of different methods for identifying and isolating individual discriminating variables are possible, in this example, a k-nearest neighbors (KNN) approach was implemented. The KNN algorithm has a number of advantages in this application, including scalability to higher-dimension biomarkers and inclusion of additional data as it becomes available. Once each variable in the dataset has been rated for diagnostic efficacy, those that are most useful in discriminating among subject classes are retained. In the current example, the 250 individual variables that best discriminated subjects with disease from those without were retained as individual discriminating variables.

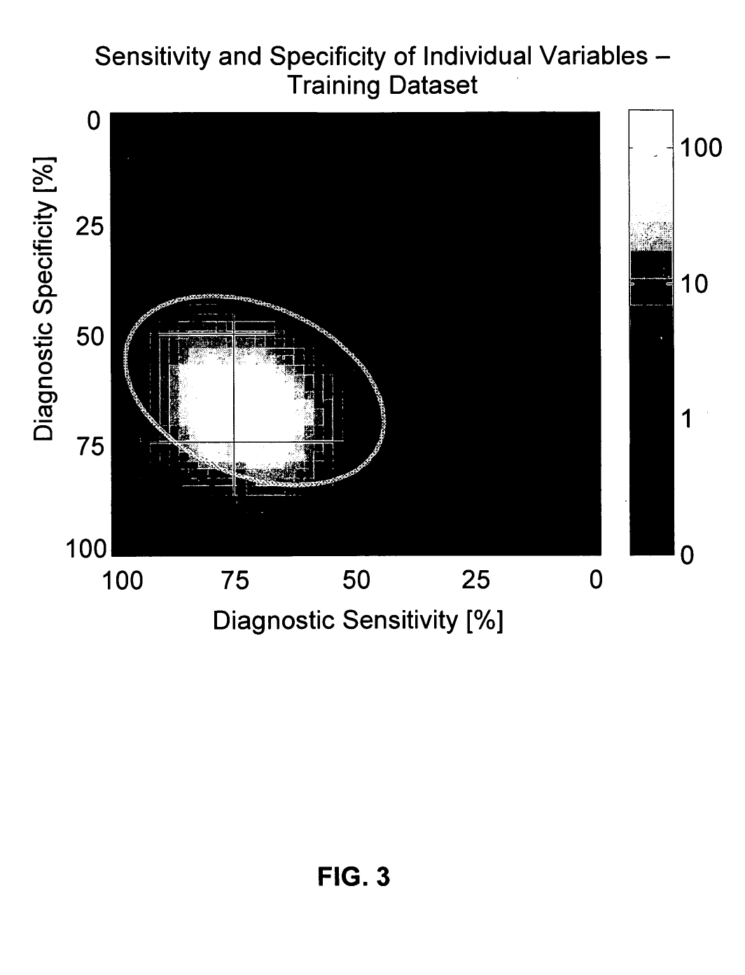

FIG. 3 shows the sensitivity and specificity distribution among all individual m/z bins within the mass spectra of subjects designated to comprise the training dataset from within the overall ovarian cancer dataset. It is from these individual bins that the 250 individual discriminating variables are selected. The oval that overlies the plot in FIG. 3 shows the approximate range of diagnostic performance using the same dataset but randomizing class membership across all subjects. M/z bins that show performance outside of the oval, and particularly those closer to perfect performance, can be thought of as better-than-chance diagnostic variables. It is from the set of m/z bins with performance outside of the oval that the 250 individual diagnostic variables are selected for further analysis.

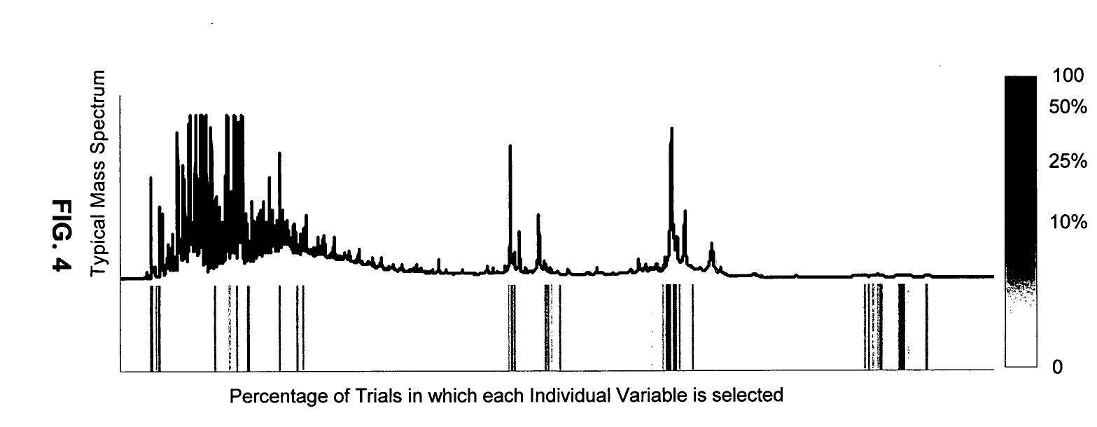

FIG. 4 illustrates the frequency with which each component of a mass spectral dataset is selected as an individual discriminating variable. The top of the figure shows a typical spectrum from the ovarian cancer dataset. The lower portion of the figure is a grayscale heat map demonstrating the percentage of trials in which each spectral component was selected. Darker shading of the heat map indicates spectral regions that were selected more consistently. From this figure it is clear that there are a large number of components within the low molecular weight region (≦20 kDa) of the proteome that play an important role in diagnostic profiling. Further, the figure illustrates how the most consistently selected regions correspond to regions of the spectra that contain peaks and are generally not contained in regions of noise.

### 6.3. Construction of Intermediate Combined Classifiers

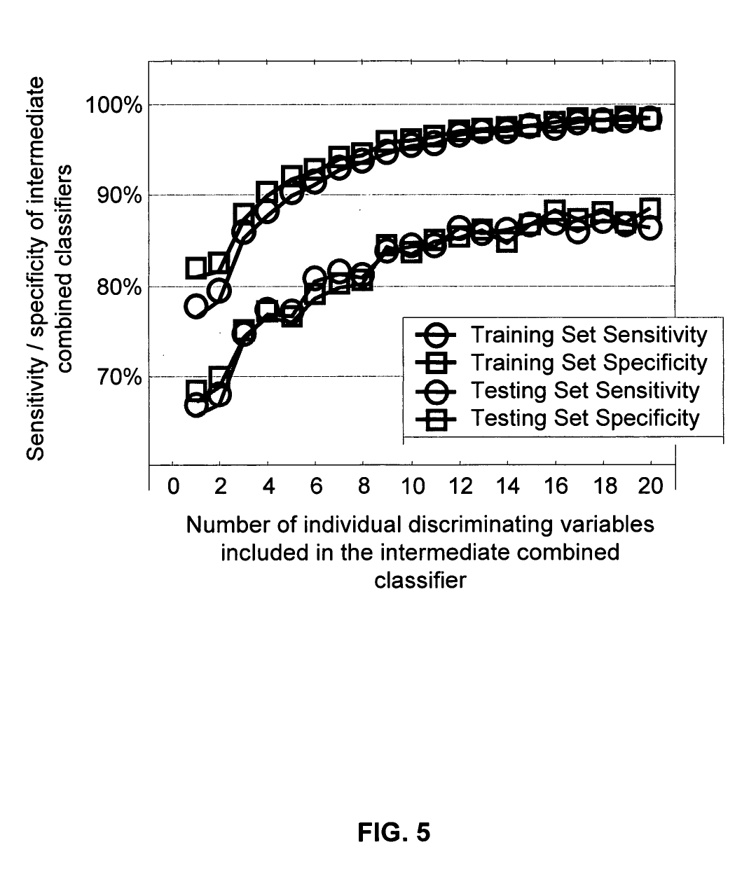

Steps 108-110—construction of intermediate combined classifiers. Once the dataset of the present example has been culled to a more manageable number of individual discriminating variables, such variables are combined into cohesive feature sets termed intermediate combined classifiers. Cohesiveness can be determined in several different ways. Examples of cohesive individual discriminating variables are those that effectively identify a similar subset of study subjects in the training population. These variables may have only modest individual diagnostic efficacy. Overall specificity can be improved, however, by combining such variables through a Boolean ‘AND’ operation. FIG. 5 illustrates.

The traces plotted in FIG. 5 are the average sensitivities and specificities of intermediate combined classifiers created as a combination of multiple individual discriminating variables. The number of individual discriminating variables used to create the intermediate combined classifiers illustrated in FIG. 5 was varied and is shown along the lower axis. For this analysis, m/z bins were randomly selected from among the culled individual discriminating variables eligible for inclusion in each intermediate combined classifier. For this reason, performance values represent a ‘worst case scenario’ and should only improve as individual discriminating variables are selected with purpose. The black (upper) traces are from the training population analysis and the gray (lower) traces show performance on the testing population analysis. Details on the construction of the training population and the testing population are provided in Section 6.5. The results illustrated in FIG. 5 show how intermediate combined classifiers improve upon the performance of individual discriminating variables. Each plotted datapoint in FIG. 5 is the average performance of fifty calculations using randomly selected individual discriminating variables to form a group and combining them using a weighted average method. FIG. 5 shows that the performance improvement realized by intermediate combined classifiers is effectively generalized to the testing population even though this population was not used to select individual discriminating variables or to construct intermediate combined classifiers.

Conversely, an intermediate combined classifier can be defined by individual discriminating variables each of which accurately classifies largely non-overlapping subsets of study subjects. Once again, across the entire set of subjects in the training population, these individual discriminating variables might not appear to be outstanding diagnostic biomarkers. Combining the group through an ‘OR’ operation can lead to improved sensitivity. In each of these examples, the diagnostic efficacy of the combined group is stronger than that of the individual discriminatory variables. This concept illustrates the basis for the construction of intermediate combined classifiers.

In practice, straightforward examples such as those given above rarely exist. More sophisticated methods of discovering cohesive subsets of individual discriminating variables and of combining those subsets to improve diagnostic accuracy are used in such instances. In this example, spectral location in the underlying mass spectrometry dataset is used to collect individual discriminating variables into groups. More specifically, all individual discriminating variables that are to be grouped together come from a similar region of the mass data spectrum (e.g., similar m/z values). In this example, imposition of this spectral location criterion means that individual discriminating variables will be grouped together provided that they represent sequential values in the m/z sampling space or that the gap between neighboring individual discriminating variables is not greater than a predetermined cutoff value that is application specific (30 in this example).

In the present example, a weighted averaging method is used to combine the individual discriminating variables in a group in order to form an intermediate combined classifier. This weighted averaging method is repeated for each of the remaining groups in order to form a corresponding plurality of intermediate combined classifiers. In the weighted averaging method approach, each intermediate combined classifier is a weighted average of all grouped individual discriminating variables. The weighting coefficients are determined based on the ability of each individual discriminating variable to accurately classify the subjects in the training population by itself. The ability of an individual discriminating variable to discriminate between known subject classes can be determined using methods such as application of a t-test or a nearest neighbors algorithm. T-tests are described in Smith, 1991, Statistical Reasoning, Allyn and Bacon, Boston, Mass., pp. 361-365, 401-402, 461, and 532, which is hereby incorporated by reference in its entirety. The nearest neighbors algorithm is described in Duda et al., 2001, Pattern Classification, John Wiley & Sons, Inc., which is hereby incorporated by reference in its entirety. An individual discriminating variable that is, by itself, more discriminatory, will receive heavier weighting than other individual discriminating variables that do not classify subjects in the training population as accurately. In this example, the nearest neighbor algorithm was used to determine the ability of each individual discriminating variable to accurately classify the subjects in the training population by itself.

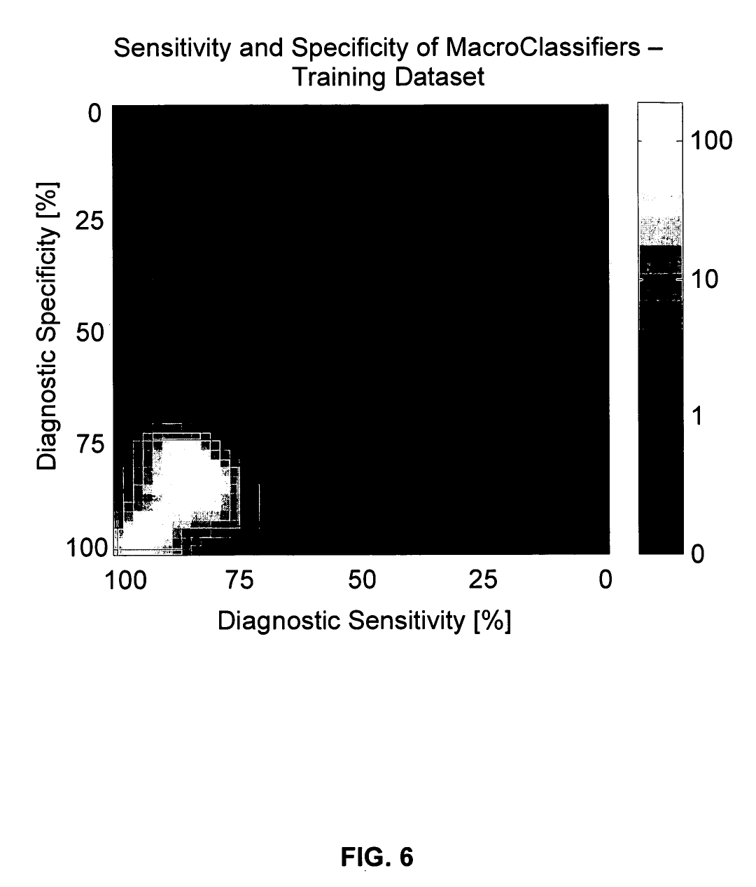

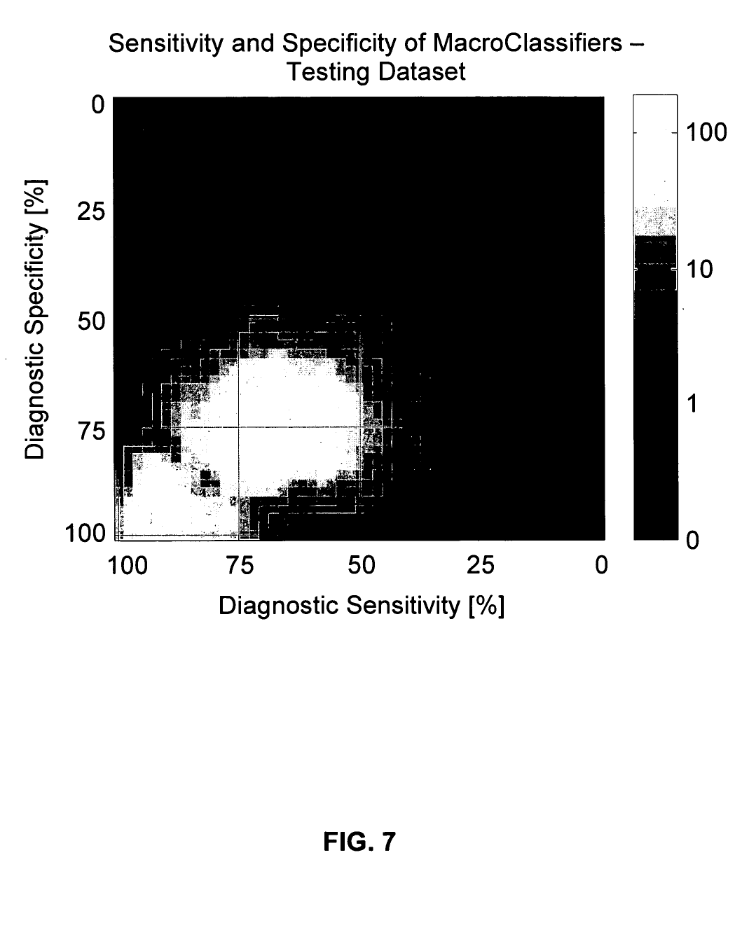

The distribution of sensitivities and specificities for all intermediate combined classifiers calculated in all 1000 cross-validation trials (see Section 6.5) using the ovarian dataset is shown in FIGS. 6 and 7 for the training population (training dataset) and the testing population (testing dataset) respectively. A direct comparison between FIGS. 3 and 6 shows the improved performance achieved when moving from individual discriminatory variables to intermediate combined classifiers. FIG. 6 shows that any of the intermediate combined classifiers (MacroClassifiers) will perform at least as well as its constituent individual discriminating variables when applied to the training population. In FIG. 7 the improvement is not as clear at first. In this figure, showing the performance of intermediate combined classifiers on the testing data, there is a general broadening of the range of diagnostic performance as individual discriminating variables are combined into intermediate combined classifiers. FIG. 7 is particularly interesting, however, because aside from the overall broadening of the performance range, there is a secondary mode of the distribution that projects in the direction of improved performance. This illustrates the dramatic improvement and generalization of a large number of intermediate combined classifiers over their constituent individual discriminating variables.

### 6.4. Construction of a Meta Classifier

Step 112—construction of a meta classifier. The ultimate goal of clinical diagnostic profiling is a single diagnostic variable that can definitively distinguish subjects with one phenotypic state (e.g., a disease state), also termed a subject class, from those with a second phenotypic state (e.g., a disease free state). In this example, an ensemble diagnostic approach is used to achieve this goal. Specifically, individual discriminating variables are combined into intermediate combined classifiers that are in turn combined to form a meta classifier. The true power of this approach lies in the ability to accommodate, within its hierarchical framework, a wide range of subject subtypes, various stages of pathology, and inter-subject variation in disease presentation. A further advantage is the ability to incorporate information from all available sources.

Creating a meta classifier from multiple intermediate combined classifiers is directly analogous to generating a intermediate combined classifier from a group of individual discriminating variables. During this step of hierarchal classification, intermediate combined classifiers that generally have a strong ability to accurately classify a subset of the available subjects in the training population are grouped and combined with the goal of creating a single strong classifier of all available subjects. Once again, a wide range of algorithmic approaches tailored to this step of the process have been proposed and are within the scope of the present invention.

In this example, a stepwise regression algorithm is used to discriminate between subjects with disease and those without. Stepwise model-building techniques for regression designs with a single dependent variable are described in numerous sources. See, for example, Darlington, 1990, Regression and linear models, New York, McGraw-Hill; Hocking, 1996, Methods and Applications of Linear Models, Regression and the Analysis of Variance, New York, Wiley; Lindeman et al., 1980, Introduction to bivariate and multivariate analysis, New York, Scott, Foresman, & Co; Morrison, 1967, Multivariate statistical methods, New York, McGraw-Hill; Neter et al., 1985, Applied linear statistical models: Regression, analysis of variance, and experimental designs, Homewood, Ill., Irwin; Pedhazur, 1973, Multiple regression in behavioral research, New York, Holt, Rinehart, & Winston; Stevens, 1986, Applied multivariate statistics for the social sciences, Hillsdale, N.J., Erlbaum; and Younger, 1985, A first course in linear regression (2nd ed.), Boston, Duxbury Press, each of which is hereby incorporated by reference in its entirety. The basic procedure involves (1) identifying an initial model, (2) iteratively “stepping,” that is, repeatedly altering the model at the previous step by adding or removing a predictor variable in accordance with the “stepping criteria,” and (3) terminating the search when stepping is no longer possible given the stepping criteria, or when a specified maximum number of steps has been reached. The following provide details on the use of stepwise model-building procedures.

The Initial Model in Stepwise Regression. The initial model is designated the model at Step zero. For the backward stepwise and backward removal methods, the initial model also includes all effects specified to be included in the design for the analysis. The initial model for these methods is therefore the whole model.

For the forward stepwise and forward entry methods, the initial model always includes the regression intercept (unless the No intercept option has been specified). The initial model may also include one or more effects specified to be forced into the model. If j is the number of effects specified to be forced into the model, the first j effects specified to be included in the design are entered into the model at Step zero. Any such effects are not eligible to be removed from the model during subsequent Steps.

Effects may also be specified to be forced into the model when the backward stepwise and backward removal methods are used. As in the forward stepwise and forward entry methods, any such effects are not eligible to be removed from the model during subsequent Steps.

The Forward Entry Method. The forward entry method is a simple model-building procedure. At each Step after Step zero, the entry statistic is computed for each effect eligible for entry in the model. If no effect has a value on the entry statistic which exceeds the specified critical value for model entry, then stepping is terminated, otherwise the effect with the largest value on the entry statistic is entered into the model. Stepping is also terminated if the maximum number of steps is reached.

The Backward Removal Method. The backward removal method is also a simple model-building procedure. At each Step after Step zero, the removal statistic is computed for each effect eligible to be removed from the model. If no effect has a value on the removal statistic which is less than the critical value for removal from the model, then stepping is terminated, otherwise the effect with the smallest value on the removal statistic is removed from the model. Stepping is also terminated if the maximum number of steps is reached.

The Forward Stepwise Method. The forward stepwise method employs a combination of the procedures used in the forward entry and backward removal methods. At Step one the procedures for forward entry are performed. At any subsequent step where two or more effects have been selected for entry into the model, forward entry is performed if possible, and backward removal is performed if possible, until neither procedure can be performed and stepping is terminated. Stepping is also terminated if the maximum number of steps is reached.

The Backward Stepwise Method. The backward stepwise method employs a combination of the procedures used in the forward entry and backward removal methods. At Step 1 the procedures for backward removal are performed. At any subsequent step where two or more effects have been selected for entry into the model, forward entry is performed if possible, and backward removal is performed if possible, until neither procedure can be performed and stepping is terminated. Stepping is also terminated if the maximum number of steps is reached.

Entry and Removal Criteria. Either critical F values or critical p values can be specified to be used to control entry and removal of effects from the model. If p values are specified, the actual values used to control entry and removal of effects from the model are 1 minus the specified p values. The critical value for model entry must exceed the critical value for removal from the model. A maximum number of steps can also be specified. If not previously terminated, stepping stops when the specified maximum number of Steps is reached.

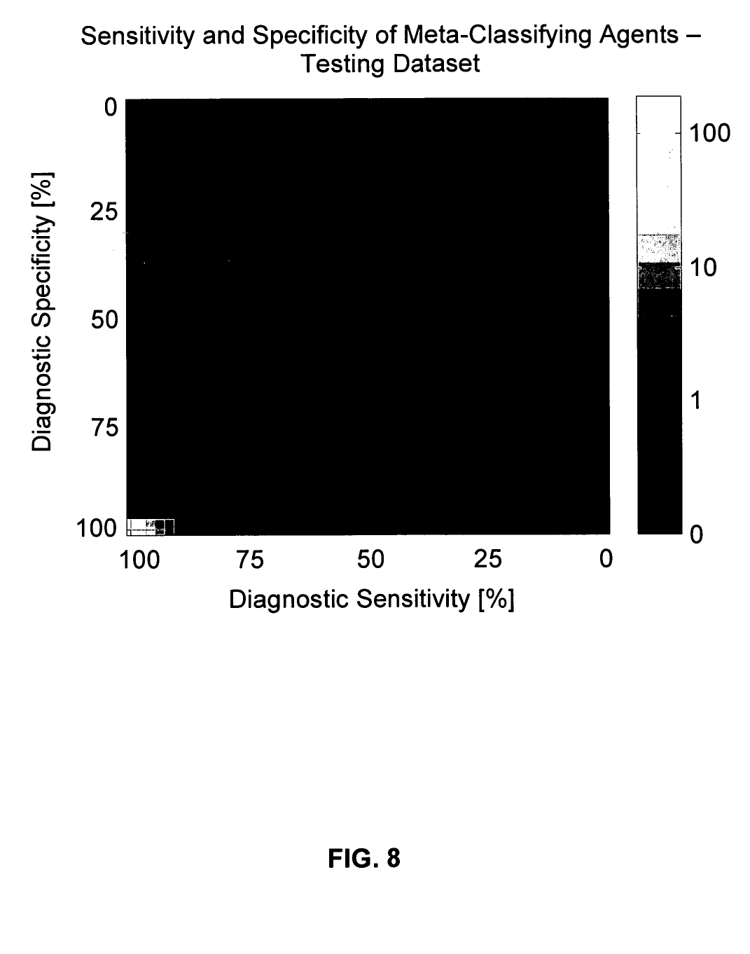

In the present example, the ‘Forward Stepwise Method’ is used with no effects included in the initial model. The entry and removal criteria are a maximum p-value of 0.05 for entry, a minimum p-value of 0.10 for removal, and no maximum number of steps. The benefits of the hierarchal classification approach used in the present example are illustrated by the performance of each meta classifier (meta-classifying agent) when applied to the testing data. These results are shown in FIG. 8. This figure can be compared to FIGS. 3 and 7 to illustrate the improvement and generalization of classifying agents at each stage of the hierarchal approach. The results in FIG. 8 represent 1000 cross-validation trials from the ovarian cancer dataset with over 700 (71.3%) instances of perfect performance with sensitivity and specificity both equal to 100%.

### 6.5. Method Validation

Benchmarking of the meta classifier derived for this example was achieved through cross-validation. Each serum mass spectrometry dataset was separated into training population set (80% each of case and control subjects) and testing population sets (20% each of case and control subjects) through randomized selection. The meta classifier was derived using the training population as described above. The meta classifier was then applied to the previously blinded testing population. Results of these analyses were gauged by the sensitivity and the specificity of distinguishing subjects with disease from those without across the testing population. Cross-validation included a series of 1000 such trials, each with a unique separation of the data into training and testing populations. The range of sensitivity and specificity achieved, along with the percentage of trials that resulted in perfect performance (sensitivity=specificity=1), are reported in Table 1 for both the ovarian cancer and the prostate cancer sets.

TABLE 1
Cross-Validation Performance

| | | | |
|---|---|---|---|
| Range | Mean | Median | Perfect |

OVARIAN CANCER DATASET

| | | | | |
|---|---|---|---|---|
| Sensitivity | 96.3%-100% | 99.9% | 100% | 97.1% |
| Specificity | 77.2%-100% | 98.9% | 100% | 91.2% |

Perfect Sensitivity and Specificity in 88.2% of Trials
PROSTATE CANCER DATASET

| | | | | |
|---|---|---|---|---|
| Sensitivity | 66.7%-100% | 89.9% | 100% | 53.2% |
| Specificity | 66.7%-100% | 94.2% | 100% | 59.0% |

Perfect Sensitivity and Specificity in 32.0% of Trials

As illustrated in Table 1, analysis of the ovarian cancer dataset yielded 100% sensitivity in 97.1% of the 1000 trials and 100% specificity in 91.2% of trials. Perfect discrimination of the testing subjects (both sensitivity and specificity equal to 100%) occurred 88.2% of the time. Sensitivity ranged from 96.3% to 100% and specificity ranged from 77.2% to 100%.

Analysis of the prostate dataset led to more modest results across all metrics. For these data, perfect discrimination was achieved 32% of the time with 100% sensitivity and specificity occurring in 53.2% and 59% of trials respectively. While sensitivity and specificity values as low as 66.7% were returned in this analysis, mean values of 89.9% and 94.2% respectively, and medians of 100% each were still achieved.

### 7. CONCLUSION

A number of references are cited herein, the entire disclosures of which are incorporated herein, in their entirety, by reference for all purposes. Further, none of these references, regardless of how characterized above, is admitted as prior art to the invention of the subject matter claimed herein.

When introducing elements of the present invention or the embodiment(s) thereof, the articles “a,” “an,” “the,” and “said” are intended to mean that there are one or more of the elements. The terms “comprising,” “including,” and “having” are intended to be inclusive and to mean that there may be additional elements other than the listed elements.

The present invention can be implemented as a computer program product that comprises a computer program mechanism embedded in a computer readable storage medium. For instance, the computer program product could contain the program modules shown in FIG. 9. These program modules may be stored on a CD-ROM, DVD, magnetic disk storage product, or any other computer readable data or program storage product. The software modules in the computer program product can also be distributed electronically, via the Internet or otherwise, by transmission of a computer data signal (in which the software modules are embedded) on a carrier wave.

The invention described and claimed herein is not to be limited in scope by the preferred embodiments herein disclosed, since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims.

1. A method of identifying a meta classifier that can discriminate between a plurality of known subject classes exhibited by a species, the method comprising:
a) independently assigning a score, for each respective physical variable in a plurality of physical variables, to a physical variable in said plurality of physical variables, wherein each assigned score represents an ability for the physical variable corresponding to the assigned score to correctly classify a plurality of biological samples into correct ones of said plurality of known subject classes;
b) retaining, as a plurality of individual discriminating variables, those physical variables in said plurality of physical variables that are best able to classify said plurality of biological samples into correct ones of said plurality of known subject classes;
c) determining a plurality of groups, wherein each group comprises an independent subset of the plurality of individual discriminating variables;
d) combining, for each respective group in said plurality of groups, said independent subset of the plurality of individual discriminating variables, thereby forming a corresponding plurality of intermediate combined classifiers; and
e) combining said plurality of intermediate combined classifiers into said meta classifier.

2. The method of claim 1, wherein said independently assigning a score, step a), comprises:
i) classifying each respective biological sample in said plurality of biological samples from said species into one of said plurality of known subject classes based on a value for a first physical variable of said respective biological sample compared with corresponding ones of the values for said first physical variable of other biological samples in said plurality of biological samples;
ii) assigning a score to said first physical variable that represents an ability for the first physical variable to accurately classify said plurality of biological samples into correct ones of said plurality of known subject classes; and
iii) repeating said classifying step i) and said assigning step ii) for each physical variable in said plurality of physical variables associated with said plurality of biological samples, thereby assigning a score to each physical variable in said plurality of physical variables.

3. The method of claim 2, wherein said classifying step i) is performed by applying a nearest neighbor classification algorithm to said first physical variable.

4. The method of claim 3 wherein said nearest neighbor algorithm classifies said plurality of biological samples using the values of said first physical variable across said plurality of biological samples.

5. The method of claim 3 wherein said nearest neighbor algorithm classifies said plurality of biological samples using the values of a plurality of more than one physical variable across said plurality of biological samples, wherein the more than one physical variable comprises said first physical variable.

6. The method of claim 3 wherein said nearest neighbor algorithm utilizes a calculated distance between the values of said first physical variable to classify each biological sample in said plurality of samples into a subject class in said plurality of subject classes.

7. The method of claim 6 wherein said calculated distance is a Euclidean distance, a standardized Euclidean distance, a Mahalanobis distance, a city block distance, a Minkowski, correlation, a Hamming distance, or a Jaccard coefficient.

8. The method of claim 2, wherein said score is based on one or more of (i) a number of biological samples classified correctly in a subject class, (ii) a number of biological samples classified incorrectly in a subject class, (iii) a relative number of biological samples classified correctly in a subject class, (iv) a relative number of biological samples classified incorrectly in a subject class, (v) a sensitivity of a subject class, (vi) a specificity of a subject class, and (vii) an area under a receiver operator curve computed for a subject class based on results of said classifying.

9. The method of claim 2, wherein said score is determined by a strength of a correct or an incorrect classification among a subset of said plurality of biological samples.

10. The method of claim 2, wherein said score is determined by a correct classification of one or more specific biological samples into their said associated subject classes.

11. The method of claim 1, wherein said plurality of physical variables are obtained by:
i) collecting said plurality of biological samples from a corresponding plurality of subjects belonging to said two or more known subject classes such that each respective biological sample in said plurality of biological samples is assigned the subject class, in the two or more known subject classes, of the corresponding subject from which the respective sample was collected; and
ii) measuring said plurality of physical variables from each respective biological sample in said plurality of biological samples such that the measured values of said physical variables for each respective biological sample in said plurality of biological samples are directly comparable to corresponding ones of said physical variables across said plurality of biological samples.

12. The method of claim 1, wherein a biological sample in said plurality of biological samples comprises a tissue, serum, blood, saliva, plasma, nipple aspirant, synovial fluid, cerebrospinal fluid, sweat, urine, fecal matter, tears, bronchial lavage, a swabbing, a needle aspirant, semen, vaginal fluid, or pre-ejaculate sample of a member of said species.

13. The method of claim 1, wherein a subject class in said plurality of known subject classes comprises an existence of a pathologic process, an absence of a pathological process, a relative progression of a pathologic process, an efficacy of a therapeutic regimen, or a toxicological reaction to a therapeutic regimen.

14. The method of claim 1, wherein a physical variable in said plurality of physical variables represents a measure of a relative or absolute amount of a predetermined component in each sample in said plurality of samples.

15. The method of claim 14, wherein said measure of the relative or absolute amount of the predetermined component in each sample is generated by mass spectrometry, or nuclear magnetic resonance spectrometry.

16. The method of claim 1, wherein a group in said plurality of groups is determined in step c) by one or more of:
i) an ability of a physical variable in said plurality of physical variables to classify said plurality of biological samples into their known subject classes;
ii) a similarity or difference in a subset of said biological samples that a physical variable is independently able to classify into a subject class,
iii) a similarity or difference in a type of physical attribute represented by a physical variable;
iv) a similarity or a difference in a range, a variation, or a distribution of values for a physical variable across said plurality of biological samples;
v) a supervised clustering of said plurality of physical variables based subclasses that are known or hypothesized to exist across said plurality of biological samples; and
vi) a unsupervised clustering of said plurality of physical variables.

17. The method of claim 1 wherein said combining step d) is determined by one or more of:
i) an ability of the intermediate combined classifier to separate all or a portion of said plurality of biological samples into their respective subject classes;
ii) an ability of the intermediate combined classifier to separate a subset of said biological samples into a plurality of unknown subclasses;
iii) an ability of the intermediate combined classifier to separate a subset of said biological samples, all of which belong to the same subject class, into a plurality of subclasses to which those biological samples are also known to belong; and
iv) an ability of the intermediate combined classifier to accurately separate a subset of said biological samples, which are known to belong to a plurality of said associated sample classes, into a plurality of subclasses to which those biological samples are also known to belong.

18. The method of claim 1 wherein said combining step d) comprises calculating an average or a weighted average of the values of each individual discriminating variable within a group in said plurality of groups.

19. The method of claim 18 wherein said weighted average is used and wherein said weighted average is determined based on an ability of each individual discriminating variable within said group to classify said plurality of biological samples into respective subject classes.

20. The method of claim 1 wherein said combining step d) comprises calculating a nonlinear combination of the values of all individual discriminating variables within a group in said plurality of groups.

21. The method of claim 20 wherein said nonlinear combination is determined by an artificial neural network.

22. The method of claim 1 wherein said combining step e) is determined by an ability of the meta classifier to separate said plurality of biological samples into their respective subject classes.

23. The method of claim 1 wherein said combining step e) comprises calculating an average or a weighted average of the values of each intermediate combined classifier in said plurality of intermediate combined classifiers.

24. The method of claim 23 wherein said weighted average is used and wherein said weighted average is determined based on an ability of each intermediate combined classifier in said plurality of intermediated combined classifiers to classify said plurality of biological samples into respective subject classes.

25. The method of claim 1 wherein said combining step e) comprises calculating a nonlinear combination of the values of all intermediate combined classifiers in said plurality of intermediate combined classifiers.

26. The method of claim 25 wherein said nonlinear combination is determined by an artificial neural network.

27. The method of claim 1, the method further comprising applying said meta classifier to data collected from a biological sample that is not in said plurality of biological samples, thereby classifying said biological sample into one of said plurality of subject classes.

28. A method of identifying one or more discriminatory patterns in multivariate data, the method comprising:
a) collecting a plurality of biological samples from a corresponding plurality of subjects belonging to two or more known subject classes such that each respective biological sample in said plurality of biological samples is assigned the subject class, in the two or more known subject classes, of the corresponding subject from which the respective sample was collected, and wherein each subject in the plurality of subjects is a member of the same species;
b) measuring a plurality of physical variables from each respective biological sample in said plurality of biological samples such that the measured values of said physical variables for each respective biological sample in said plurality of biological samples are directly comparable to corresponding ones of said physical variables across said plurality of biological samples;
c) classifying each respective biological sample in said plurality of biological samples based on a measured value from step b) for a first physical variable of said respective biological sample compared with corresponding ones of the measured values from step b) for said first plurality physical variable of other biological samples in said plurality of biological samples;
d) assigning an independent score to said first physical variable in said plurality of physical variable that represents an ability for the first physical variable to accurately classify said plurality of biological samples into correct ones of said two or more known subject classes;
e) repeating said classifying and assigning for each physical variable in said plurality of physical variables, thereby assigning an independent score to each physical variable in said plurality of physical variables;
f) retaining, as a plurality of individual discriminating variables, those physical variables in said plurality of physical variables that are best able to classify said plurality of biological samples into correct ones of said two or more known subject classes;
g) determining a plurality of groups, wherein each group comprises an independent subset of the plurality of individual discriminating variables;
h) combining each individual discriminating variable in a group in said plurality of groups thereby forming an intermediate combined classifier;
i) repeating said combining step h) for each group in said plurality of groups, thereby forming a plurality of intermediate combined classifiers; and
j) combining said plurality of intermediate combined classifiers into a meta classifier.

29. A computer program product for use in conjunction with a computer system, the computer program product comprising a computer readable storage medium and a computer program mechanism embedded therein, the computer program mechanism comprising:
instructions for independently assigning a score, for each respective physical variable in a plurality of physical variables, to a physical variable in said plurality of physical variables, wherein each assigned score represents an ability for the physical variable corresponding to the assigned score to correctly classify a plurality of biological samples into correct ones of a plurality of known subject classes;
instructions for retaining, as a plurality of individual discriminating variables, those physical variables in said plurality of physical variables that are best able to classify said plurality of biological samples into correct ones of said plurality of known subject classes;
instructions for determining a plurality of groups, wherein each group comprises an independent subset of the plurality of individual discriminating variables;
instructions for combining, for each respective group in said plurality of groups, each individual discriminating variable in the respective group, thereby forming a corresponding plurality of intermediate combined classifiers; and
instructions for combining said plurality of intermediate combined classifiers into a meta classifier.

30. A computer comprising:
one or more central processing units;
a memory, coupled to the one or more central processing units, the memory storing:
instructions for independently assigning a score, for each respective physical variable in a plurality of physical variables, to a physical variable in said plurality of physical variables, wherein each assigned score represents an ability for the physical variable corresponding to the assigned score to correctly classify a plurality of biological samples into correct ones of a plurality of known subject classes;
instructions for retaining, as a plurality of individual discriminating variables, those physical variables in said plurality of physical variables that are best able to classify said plurality of biological samples into correct ones of said plurality of known subject classes;
instructions for determining a plurality of groups, wherein each group comprises an independent subset of the plurality of individual discriminating variables;
instructions for combining, for each respective group in said plurality of groups, each individual discriminating variable in the respective group, thereby forming a corresponding plurality of intermediate combined classifiers; and
instructions for combining said plurality of intermediate combined classifiers into a meta classifier.
